(19) United States
(12) Patent Application Publication
(10) Pub. No.: US 2026/0154012 A1
(43) Pub. Date: Jun. 4, 2026

(54) INFORMATION PROCESSING APPARATUS, INFORMATION PROCESSING SYSTEM, CONTROL METHOD FOR INFORMATION PROCESSING APPARATUS, AND STORAGE MEDIUM

(71) Applicant: CANON KABUSHIKI KAISHA, Tokyo (JP)

(72) Inventor: HIROAKI HANAI, Chiba (JP)

(21) Appl. No.: 19/395,630

(22) Filed: Nov. 20, 2025

(30) Foreign Application Priority Data
Dec. 2, 2024 (JP) 2024-209751

(51) Int. Cl. G06F 3/12; H04N 1/00; H04N 1/32

(52) U.S. Cl. CPC G06F 3/1208; G06F 3/1205; G06F 3/121; G06F 3/1234; G06F 3/1256; G06F 3/1261; H04N 1/00413; H04N 1/32539; G06F 3/1288; H04N 2201/0094

(57) ABSTRACT

An information processing apparatus capable of communicating with a cloud print server that provides a cloud print service, the information processing apparatus comprising: one or more memory devices that store a set of instructions; and one or more processors that execute the set of instructions to: obtain specific information regarding an image formation of an image forming apparatus capable of communicating with the cloud print server; accept a setting in accordance with the obtained specific information, the setting pertaining to the image formation in the image forming apparatus; and issue an instruction for the image formation in the image forming apparatus, the instruction including the setting.

### BACKGROUND

### Field of the Technology

The present disclosure relates to an information processing apparatus, an information processing system, a control method for an information processing apparatus, and a storage medium.

### Description of the Related Art

Thus far, a printer driver installed in a terminal has communicated directly with an image forming apparatus such as a multifunction peripheral using TCP/IP information or the like. In other words, the printer driver obtains configuration information or the like from an image forming apparatus associated with the printer driver and generates a print settings screen based on that information. Here, the configuration information includes, for example, information on the state of attachment of a finisher to the image forming apparatus and the like. Even among image forming apparatuses of the same model, such information is specific to that particular image forming apparatus. In other words, a stapling function of the image forming apparatus changes depending on the attachment state of the finisher. If the finisher is attached, stapling is treated as being enabled, whereas if the finisher is removed, stapling is treated as being disabled. The user can determine the print settings to be applied to sheets output from the image forming apparatus through a print settings screen in which such specific information can be set. In addition, upon receiving a print instruction, the printer driver generates a print job on the basis of print data and the print settings, and transmits the print job to the image forming apparatus.

On the other hand, with the recent spread of cloud print platforms, cloud print services in which a print service provided in the cloud and an image forming apparatus operate in conjunction with each other are becoming more and more common. Microsoft's Universal Print can be given as an example of a cloud print service. In such a cloud print service, the printer driver does not communicate directly with the image forming apparatus, but rather transmits print jobs over the cloud, receives capability information of the image forming apparatus stored in the cloud, and the like.

Japanese Patent Laid-Open No. 2023-142275 describes using a background application as a method for communicating information between the cloud and a printer driver or between an image forming apparatus and the printer driver. The background application manages print jobs generated by the printer driver, print settings, and the like in association with the image forming apparatus. The background application also transmits the setting information to the cloud or the image forming apparatus in accordance with the settings.

Japanese Patent Laid-Open No. 2023-142275 envisions held printing, in which print jobs are accumulated in the cloud and executed by any image forming apparatus at a desired timing. Accordingly, the print setting items that can be set are setting items that are common to all of the image forming apparatuses. In other words, obtaining and managing configuration information and the like of the image forming apparatuses from the cloud or passing the configuration information and the like to the printer driver to expand the print settings is not considered. It is therefore difficult for the printer driver to generate a print settings screen that includes print setting items that correspond to the configuration information of each of the desired image forming apparatuses.

In cloud printing, it is assumed that there are multiple pieces of configuration information for image forming apparatuses registered in the cloud, and that multiple printer drivers are installed in PCs. In such an environment, it is difficult to accurately associate the printer drivers and the pieces of configuration information of the image forming apparatuses with each other. It is also difficult for the user to make print settings that correspond to the configuration information of a certain image forming apparatus. It is therefore possible that inconsistencies in the print settings may arise at the time of printing.

### SUMMARY

The present disclosure enables the realization of a new technique for enabling setting image forming settings that correspond to specific information for each of multiple image forming apparatuses in cloud printing.

One aspect of the present disclosure provides an information processing apparatus capable of communicating with a cloud print server that provides a cloud print service, the information processing apparatus comprising: one or more memory devices that store a set of instructions; and one or more processors that execute the set of instructions to: obtain specific information regarding an image formation of an image forming apparatus capable of communicating with the cloud print server; accept a setting in accordance with the obtained specific information, the setting pertaining to the image formation in the image forming apparatus; and issue an instruction for the image formation in the image forming apparatus, the instruction including the setting.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram illustrating an image forming system according to one embodiment.

FIG. 2A is a diagram illustrating the hardware configuration of an image forming apparatus according to one embodiment.

FIG. 2B is a diagram illustrating the hardware configuration of a cloud print service according to one embodiment.

FIG. 2C is a diagram illustrating the hardware configuration of an information processing terminal according to one embodiment.

FIG. 3 is a diagram illustrating the software configuration of an image forming apparatus according to one embodiment.

FIG. 4 is a diagram illustrating the software configuration of a cloud print service according to one embodiment.

FIG. 5 is a diagram illustrating the software configuration of an information processing terminal according to one embodiment.

FIG. 6 is a flowchart illustrating a processing sequence according to one embodiment.

FIG. 7 is a diagram illustrating a display screen according to one embodiment.

FIG. 8A is a diagram illustrating information of an image forming apparatus according to one embodiment.

FIG. 8B is a diagram illustrating information of an image forming apparatus according to one embodiment.

FIG. 8C is a diagram illustrating information of an image forming apparatus according to one embodiment.

FIG. 9 is a flowchart illustrating a processing sequence according to one embodiment.

FIG. 10 is a diagram illustrating a display screen according to one embodiment.

FIG. 11A is a diagram illustrating a display screen according to one embodiment.

FIG. 11B is a diagram illustrating a display screen according to one embodiment.

FIG. 12 is a flowchart illustrating a processing sequence according to one embodiment.

FIG. 13A is a diagram illustrating a display screen according to one embodiment.

FIG. 13B is a diagram illustrating a display screen according to one embodiment.

FIG. 14 is a diagram illustrating a display screen according to one embodiment.

FIG. 15 is a diagram illustrating information of an image forming apparatus according to one embodiment.

FIG. 16 is a flowchart illustrating a processing sequence according to one embodiment.

FIG. 17 is a diagram illustrating information of an image forming apparatus according to one embodiment.

FIG. 18 is a flowchart illustrating a processing sequence according to one embodiment.

FIG. 19 is a diagram illustrating a display screen according to one embodiment.

FIG. 20 is a flowchart illustrating a processing sequence according to one embodiment.

FIG. 21A is a diagram illustrating a display screen according to one embodiment.

FIG. 21B is a diagram illustrating a display screen according to one embodiment.

FIG. 22 is a flowchart illustrating a processing sequence according to one embodiment.

FIG. 23A is a diagram illustrating a display screen according to one embodiment.

FIG. 23B is a diagram illustrating a display screen according to one embodiment.

FIG. 24 is a flowchart illustrating a processing sequence according to one embodiment.

FIG. 25 is a flowchart illustrating a processing sequence according to one embodiment.

FIG. 26 is a flowchart illustrating a processing sequence according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Herein, the term “image forming apparatus” is assumed to refer broadly to any apparatus that forms (records) an image on a recording material (a recording medium), including single-function printers, copiers, multifunction peripherals, commercial printers, and the like.

Furthermore, herein, “configuration information” of an image forming apparatus includes capability information, and unique model information related to image formation performed by individual image forming apparatuses (an example of “specific information”). The capability information includes image forming capability information corresponding to print setting items common to a plurality of image forming apparatuses registered in a cloud print service (information processing apparatus) 100. The model information also includes an attachment state or an operation state of an apparatus connected to the image forming apparatus. Finally, “full-function printing” includes printing in which a printer driver generates a print settings screen including all print setting items that can be set according to the configuration of each image forming apparatus, and an end user can then designate all print settings through the print settings screen.

### Embodiment

### System Configuration

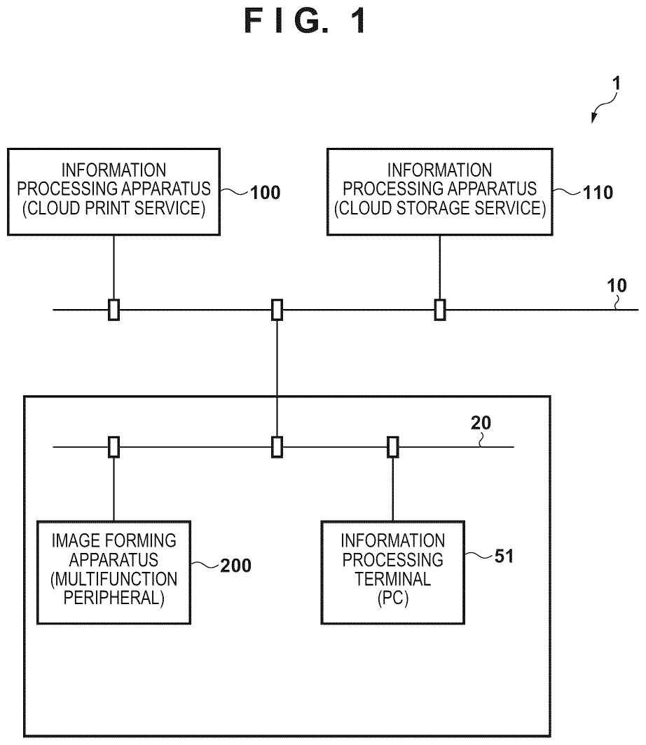

The configuration of an image forming system 1 (an example of an “information processing system”) according to the present embodiment will be described first with reference to FIG. 1. The image forming system 1 is configured including, for example, an information processing apparatus 100, an information processing apparatus 110, an information processing terminal 51, and an image forming apparatus 200, and these are connected over a network 10 or 20. Here, in the image forming system 1, an administrator may manage a single image forming apparatus 200 or a plurality of image forming apparatuses 200 collectively through the information processing apparatus 100 in, for example, a company or an organizational unit belonging to a company. In such a case, this unit of management is also referred to as a “tenant”. The information processing apparatus 100 and the information processing apparatus 110 are examples of a “cloud print server that provides a cloud print service”. The information processing terminal 51 is an example of an “information processing apparatus capable of communicating with a cloud print server that provides a cloud print service”.

The information processing apparatus 100 is a server hosted on a cloud platform, and provides a web portal to connected clients. The information processing apparatus 100 in particular is provided with a service that provides printing-related services. Hereinafter, the information processing apparatus 100 may also be referred to as a “cloud print service 100”. The information processing apparatus 110 provides a general-purpose cloud storage service, such as Google Drive (registered trademark), for example. Hereinafter, the information processing apparatus 110 may also be referred to as a “cloud storage service 110”.

The image forming apparatus 200 is a digital multifunction peripheral provided with a plurality of functions, such as a copy function, a scan function, a print function, a fax function, an email transmission function, and the like. The apparatus may instead be a printer provided with a single function. Note that the image forming apparatus 200 will be described as a printer hereinafter. Although only one image forming apparatus 200 is illustrated in FIG. 1, the number of image forming apparatuses 200 is not limited to one.

The information processing terminal 51 is, for example, a personal computer (PC), but may be an information processing terminal such as a smartphone, a tablet, or the like. A local network 20 is, for example, a network within a company office, and FIG. 1 illustrates an example in which a plurality of image forming apparatuses 200 and information processing terminals 51 used by a plurality of employees are connected within the company office.

The image forming apparatus 200 and the information processing terminal 51 are capable of communicating with the cloud print service 100 over the network 10, and are capable of using a web portal, a print service, and the like provided by the cloud print service 100. Likewise, each image forming apparatus 200 is capable of communicating with the cloud storage service 110 over the network 10, and is capable of using a file service provided by the cloud storage service 110.

### Hardware Configuration of Image Forming Apparatus 200

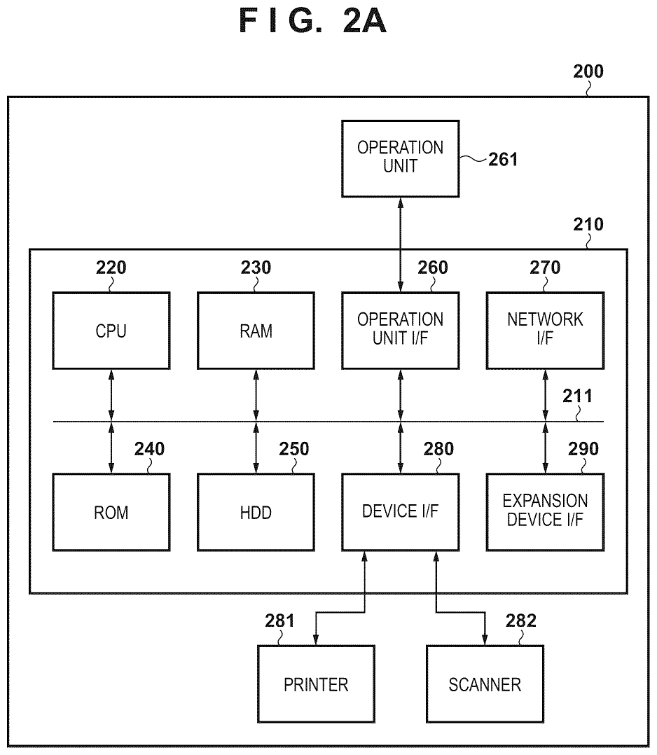

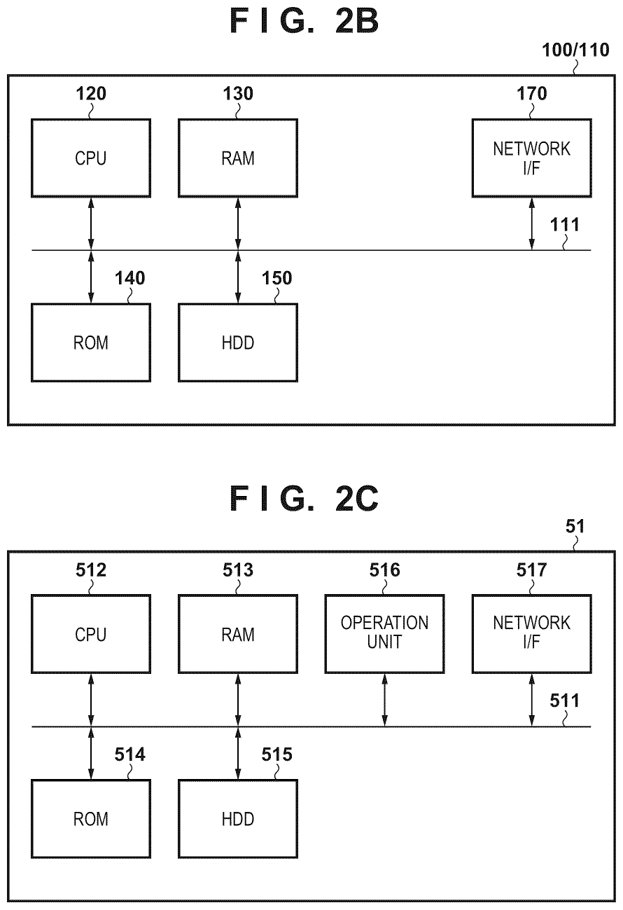

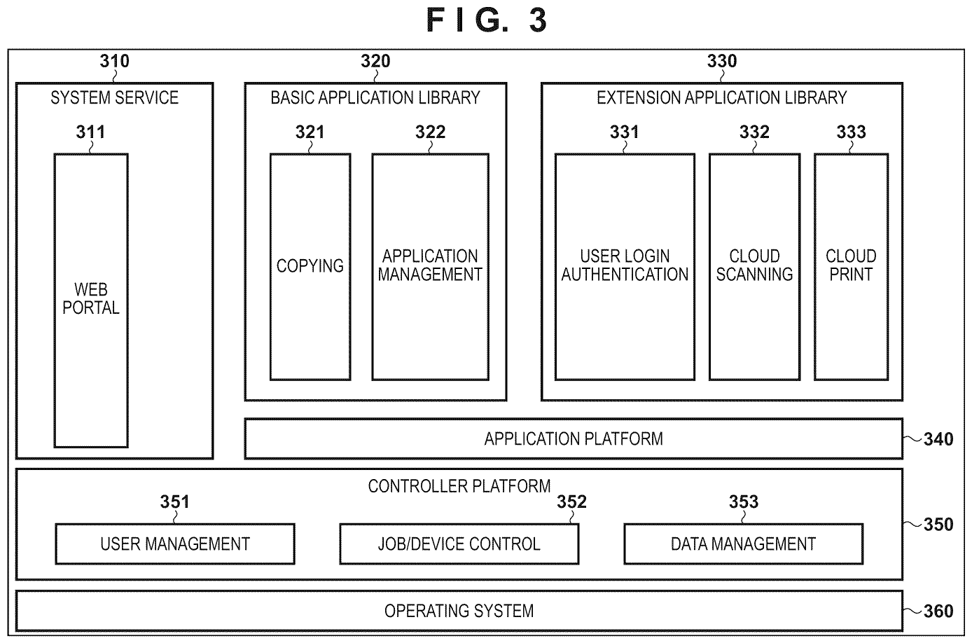

The hardware configuration of the image forming apparatus 200 will be described next with reference to FIG. 2A. The image forming apparatus 200 is a digital multifunction peripheral, for example, and is configured including a controller unit 210, an operation unit 261, a printer 281, and a scanner 282. The controller unit 210 includes a CPU 220, a RAM 230, a ROM 240, an HDD 250, an operation unit I/F 260, a network I/F 270, a device I/F 280, and an expansion device I/F 290.

The CPU 220 is a unit that executes control programs provided in the image forming apparatus 200, and controls the operations of devices connected to the controller unit through the I/Fs and storage medium memory. Programs such as operating systems, system software, application software, and the like, as well as data, are stored in the RAM 230. A system boot program, system programs, application programs, and the like are stored in the ROM 240. Furthermore, information necessary for the image forming apparatus 200, such as fonts and the like, may be stored in the ROM 204 as well. The HDD 250 is a storage device having a larger capacity than the RAM 230, and stores an operating system, system software, application software, image data, setting data, print jobs, user information, and the like. Programs stored in the HDD 250 are loaded into the RAM 230 by the CPU 220 executing programs stored in the ROM 240. The CPU 220 then executes programs loaded into the RAM 230, and processes data stored in the RAM 230, the ROM 240, and the HDD 250. Some compact multifunction peripherals are configured without the HDD 250, and system software, application software, and the like are stored in the ROM 240 instead. Alternatively, the configuration may be such that a storage device other than a hard disk, such as Flash memory constituting a solid-state disk (SSD), is used instead of the HDD 250.

The operation unit I/F 260 is an interface unit that controls input/output with the operation unit 261, which includes a touch panel, for example, and outputs image data to be displayed in the operation unit 261 to the operation unit 261. The operation unit I/F 260 also communicates, to the CPU 220, input information resulting from a user operating the operation unit 261. The network I/F 270 is configured including a communication module, connects to a network, and communicates with external devices on the network.

The device I/F 280 connects the printer 281, the scanner 282, and the like, which are image input and output devices, to the controller unit 210, and inputs and outputs image data. The CPU 220 reads a document image by controlling the scanner 282, and the read image data is stored in the RAM 230, the HDD 250, or the like through the device I/F 280. The stored image data is subjected to image processing by application programs loaded into the RAM 230 as necessary. The CPU 220 also prints the image data onto a sheet by outputting the image data to the printer 281 through the device I/F 280 and controlling the printer 281.

The expansion device I/F 290 is configured including a USB port, a wireless transceiver such as Bluetooth, or the like to enable any optional devices to be connected. The expansion device I/F 290 enables optional devices, such as an ID card reader, a biometric authentication device, or the like, to be connected to the image forming apparatus 200.

Note that the image forming apparatus 200 is not limited to the configuration illustrated in FIG. 2A. For example, the image forming apparatus 200 may be a printer that does not include the scanner 282. If the image forming apparatus 200 is a multifunction peripheral having a fax function, an I/F for a modem apparatus (not shown in FIG. 2A) may be provided in the controller unit 210, and the image forming apparatus 200 may be connected to a public line by the modem to transmit faxes.

### Hardware Configuration of Cloud Print Service 100

The hardware configuration of the cloud print service 100 will be described next with reference to FIG. 2B. The cloud print service 100 is configured including a CPU 120, a RAM 130, a ROM 140, an HDD 150, and a network I/F 170, which are connected to each other over a bus 111. The CPU 120 controls the overall operations by reading out control programs stored in the ROM 140 and executing various types of processing. The RAM 130 is used as the main memory of the CPU 120, a temporary storage region such as a work area, or the like. The HDD 150 is a high-capacity storage unit that stores image data, various types of programs, and the like. The network I/F 170 is configured including a communication module, and is an interface for connecting to the Internet. Note that the hardware configuration of the cloud storage service 110 corresponds to the hardware configuration of the cloud print service 100 illustrated in FIG. 2B, for example.

### Hardware Configuration of Information Processing Terminal 51

The hardware configuration of the information processing terminal 51 will be described next with reference to FIG. 2C. The information processing terminal 51 is configured including a CPU 512, a RAM 513, a ROM 514, an HDD 515, an operation unit 516 (an example of a “display unit”), and a network I/F 517, which are connected to each other over a bus 511. The CPU 512 controls the overall operations by reading out control programs stored in the ROM 514 and executing various types of processing. The RAM 513 is used as the main memory of the CPU 512, a temporary storage region such as a work area, or the like. The HDD 515 is a high-capacity storage unit that stores image data, various types of programs, and the like. The operation unit 516 is configured including an input device such as a keyboard and a mouse, and an output device such as a display. The operation unit 516 is an interface for inputting various operation signals to the information processing terminal 51 and displaying results of processing by the information processing terminal 51. The network I/F 517 is an interface for connecting to the Internet, and is configured including a communication module.

### Software Configuration of Image Forming Apparatus 200

The software configuration of programs executed by the CPU 220 of the image forming apparatus 200 will be described next with reference to FIG. 3. An operating system (OS) 360 provides various resource management services and frameworks optimized for controlling embedded systems for software running thereon. Specifically, the various resource management services and frameworks include multi-task management for running multiple processes substantially in parallel by managing multiple execution contexts for processing by the CPU 220, and inter-task communication for implementing synchronization and data exchange between tasks. Furthermore, the operating system 360 provides memory management, interrupt management, various device drivers, and local interfaces, as well as a protocol stack that implements processing of various protocols such as network and communication protocols, and the like, for example.

A controller platform 350 is configured including user management 351, job/device control 352, and data management 353. The user management 351 provides applications with a mechanism for managing local users, and credentials thereof, in the image forming apparatus 200 using the RAM 230 or the HDD 250. A login application implements user login control for the image forming apparatus 200 using the local user credentials managed by the user management 351. The job/device control 352 executes print jobs such as scanning, printing, and copying while controlling the printer 281 and the scanner 282 in accordance with instructions from applications. The states of devices such as the printer 281 and the scanner 282, errors in those devices, and the like are managed as well.

The data management 353 manages image data and various types of setting data required when executing a print job. The data management 353 also manages a job execution history, counter information, various types of data controlled by other applications, and model information and capability information of the image forming apparatus 200.

A system service 310 is a software module responsible for managing the controller platform 350 and operating system program updates, as well as device information/network settings and the like. Furthermore, the system service 310 is configured including a web portal 311, and can be operated from a remote terminal such as the information processing terminal 51.

An application platform 340 is middleware that can be used from various types of applications. Specifically, the operating system 360 and the mechanism of the controller platform 350 are configured to be usable from various types of applications in a basic application library 320 and an extension application library 330 (described later).

The basic application library 320 is a group of applications that provide the basic functions of the image forming apparatus 200, which are stored in the ROM 240 or the HDD 250 in an initial state at the time of purchase of the image forming apparatus 200. The extension application library 330 is a desired group of applications that are individually installed and run in order to extend the functions implemented by the image forming apparatus 200. Each application displays a screen in the operation unit 261, and implements various types of functions in response to user operations accepted by the operation unit 261.

FIG. 3 illustrates an example in which copying 321 and application management 322 are included in the basic application library 320. Copying 321 is an application for executing a copy job of scanning a document and printing onto a sheet. Application management 322 is an application for managing the installation and uninstallation of extension applications in the extension application library 330.

FIG. 3 illustrates, as an example, a state in which extension applications of user login authentication 331, cloud scanning 332, and cloud print 333 are installed as the extension application library 330. User login authentication 331 is an application that displays a screen for entering user credentials in the operation unit 261 and implements user login processing for the image forming apparatus 200 using the user credentials entered from the operation unit 261. The user login processing is implemented not only using the user credentials entered through the operation unit 261, but also using user credentials read through an ID card reader or a biometric authentication device connected through the expansion device I/F 290. User login authentication 331 communicates with the cloud print service 100 over the network I/F 270. User login authentication 331 then authenticates the user by verifying user credentials managed in the cloud print service 100 against the user credentials entered in the image forming apparatus 200. User login authentication 331 may also authenticate the user by verifying the user credentials against user credentials managed by the user management 351.

Cloud scanning 332 is an application that communicates with an unspecified cloud storage service 110 and transmits, to the cloud storage service 110, an image file read by executing a scanning job in the image forming apparatus 200. Cloud print 333 is an application that communicates with the cloud print service 100, obtains image data to be printed from the cloud print service 100, and executes a print job in the image forming apparatus 200. Cloud print 333 is an application that obtains file data to be printed from the cloud storage service 110 and executes a print job in the image forming apparatus. Cloud print 333 also transmits a result of executing the print job to the cloud print service 100.

### Software Configuration of Cloud Server

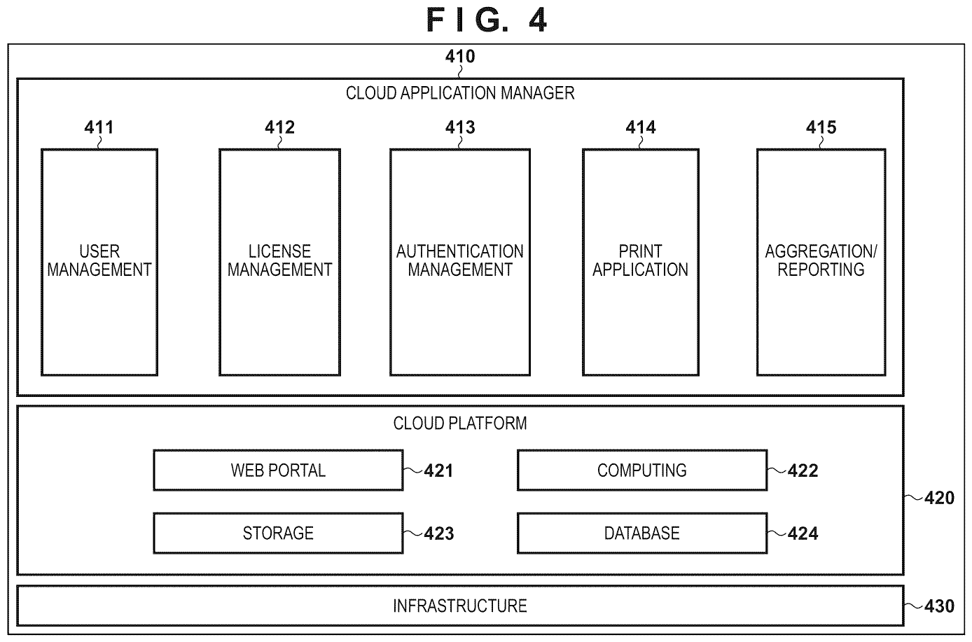

The software configuration of the cloud print service 100 will be described next with reference to FIG. 4. Infrastructure 430 is the foundation upon which the cloud server provides various services, and is configured including a server, a virtual machine, cloud storage, a network, and an operating system.

A cloud platform 420 is a framework that utilizes the infrastructure 430 to provide common basic functions to a cloud application manager 410. In other words, the cloud platform 420 is configured including a web portal 421, computing 422, storage 423, and a database 424.

The cloud application manager 410 is a group of various applications that run on the cloud platform 420. The cloud application manager 410 is configured including user management 411, license management 412, authentication management 413, a print application 414, and aggregation/reporting 415.

User management 411 centrally manages user information on the cloud print service 100. Users are registered and deleted through an operation panel of the image forming apparatus 200. User management 411 manages the user information using the database 424. User management 411 also provides an API for accepting user authentication instructions from user login authentication 331, which runs on the image forming apparatus 200, or a PC application.

License management 412 is a web application that provides a web service screen for centrally managing the applications on the cloud print service 100 using the web portal 421. Through this web service screen, the user can install and uninstall applications to be managed, as well as register licenses for the applications. License management 412 is also a web application that provides an API for accepting license registration instructions from user login authentication 331 and application management 322, which run on the image forming apparatus 200. There are cases where license registration instructed by application management 322 of the image forming apparatus 200 is successful. In such a case, license management 412 obtains an application that uses the cloud print service 100 and that runs on the image forming apparatus 200 from the storage 423 and provides the application to the image forming apparatus 200.

Authentication management 413 is a web application that provides a web service screen for setting the user login authentication method using the web portal 421. This web service screen makes it possible to set the user login authentication method for each application centrally managed on the cloud print service 100. Authentication management 413 manages the user login authentication method using the storage 423 or the database 424. Authentication management 413 is also a web application that provides an API for accepting setting information obtainment instructions from user login authentication 331, which runs on the image forming apparatus 200. Authentication management 413 is also responsible for accessing various web service screens provided by the cloud application manager 410, and user authentication during API calls.

User management 411, license management 412, and authentication management 413, which are run on the cloud print service 100, and user login authentication 331, which is run on the image forming apparatus 200, are capable of running in tandem. By running in tandem in this manner, it is possible to log in to a device linked to the cloud print service 100 using the centrally-managed user authentication method and credentials.

The print application 414 is a web application that provides an API for accepting an instruction to obtain a document to be printed, and an instruction to execute the printing, from cloud print 333, which is executed on the image forming apparatus 200, using the web portal 421. The print application 414 also provides an API for accepting a print execution instruction from the PC application. The print application 414 accepts the instruction to obtain the document to be printed and returns a list of documents to be printed that are present in the cloud storage. The print application 414 can also accept a print execution instruction and convert the print execution instruction into a data format that can be printed by the image forming apparatus 200 using computing 422. The print application 414 is also a web application that provides an API for accepting print jobs transmitted from the PC application of the information processing terminal 51, and an API for accepting print job obtainment instructions from cloud print 333. The print application 414 on the cloud server, and cloud print 333 executed on the image forming apparatus 200, are capable of running in tandem. By running in tandem, the user can execute the same print workflow in devices linked to the cloud print service 100.

Aggregation/reporting 415 is a web application that provides an API for accepting job execution results transmitted from cloud scanning 332 and cloud print 333, which are executed on the image forming apparatus 200, using the web portal 421. Aggregation/reporting 415 is also a web application that performs processing for aggregating the received job execution results and providing a web service screen that displays the aggregation results using computing 422.

Note that the various web service screens and APIs provided by the cloud application manager 410 are managed individually on a tenant-by-tenant basis. For example, a different URL is generated for each tenant. The various types of data managed by the cloud application manager 410 are also managed individually on a tenant-by-tenant basis.

### Software Configuration of Information Processing Terminal

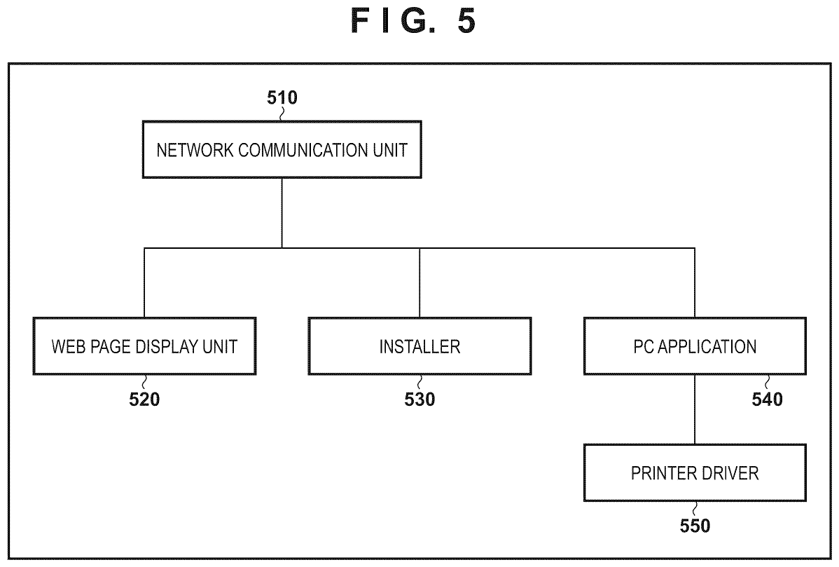

The software configuration of the information processing terminal 51 will be described next with reference to FIG. 5. A program running on the information processing terminal 51 is configured including a network communication unit 510, a web page display unit 520, an installer 530, a PC application 540, and a printer driver 550. The network communication unit 510 is a module for data communication with the cloud print service 100 connected over a network (10 or 20). The web page display unit 520 is a web browser that displays various web service screens provided by the cloud print service 100 and accepts user operations through those screens. The PC application 540 displays screens and accepts operations made in the screens.

The installer 530 is downloaded along with tenant information from the cloud print service 100. The installer 530 displays a screen in which the printer driver to be installed or the image forming apparatus to perform printing can be selected. The installer 530 then accepts the information of the printer driver and the image forming apparatus selected and operated by the end user on the screen. The installer 530 then downloads the information of the printer driver and the image forming apparatus from the cloud print service 100 through the network communication unit 510, and installs the printer driver in the information processing terminal 51.

The PC application 540 is a background application that transmits (submits) print jobs generated by the printer driver 550 in accordance with instructions from the end user to the cloud print service 100 through the network communication unit 510. The PC application 540 also obtains information from the cloud print service 100, converts the information into a configuration information format that can be identified by the printer driver 550 as necessary, and transmits the configuration information to the printer driver 550.

The printer driver 550 is a printer driver for on-demand printing where printing is possible using any desired image forming apparatus (held printing), or a printer driver specialized for a specific printer for printing using the specific printer. Such a printer driver 550 is selected by the end user through the installer 530 and installed in the information processing terminal. A plurality of printer drivers can also be installed in the information processing terminal 51. In such an information processing terminal 51, a printer queue corresponding to the number of image forming apparatuses selected by the end user is generated.

### Processing Example 1 (Processing for Registering Image Forming Apparatus 200 with Cloud Print Service 100)

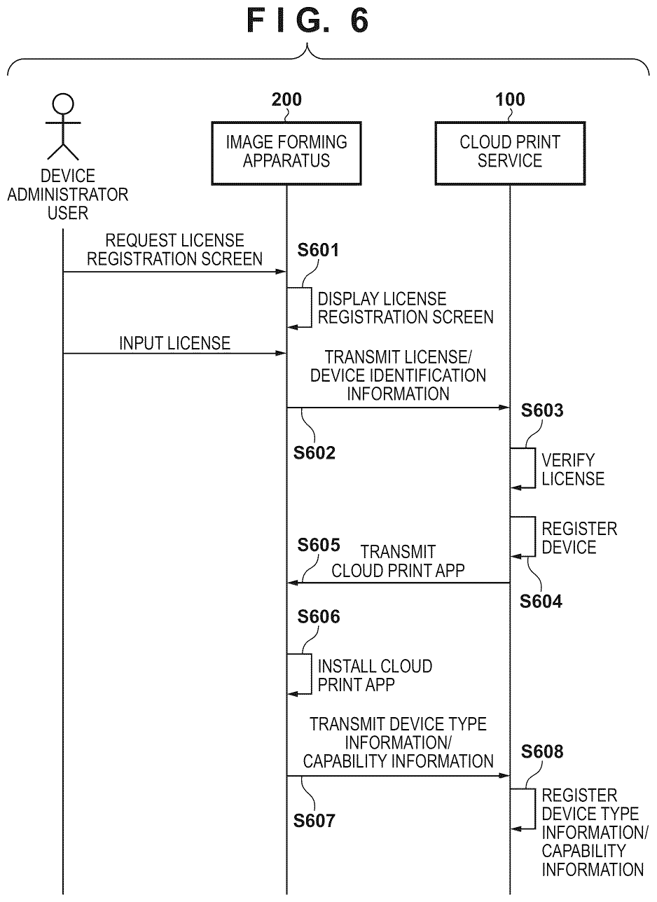

The flow of a sequence through which the image forming apparatus 200 is registered with the cloud print service 100 and an application for using the cloud print service 100 is installed in the image forming apparatus 200 will be described next with reference to FIG. 6. This sequence is realized by the image forming apparatus 200 and the cloud print service 100 executing processing for each other while communicating over the network 10. The processing by the image forming apparatus 200 is realized by programs stored in the ROM 240 being read out into the RAM 230 and executed by the CPU 220. Similarly, the processing by the cloud print service 100 is realized by programs stored in the ROM 140 being read out into the RAM 130 and executed by the CPU 120. This sequence is executed upon an instruction for execution being made by a device administrator of the image forming apparatus 200 through the operation unit 261.

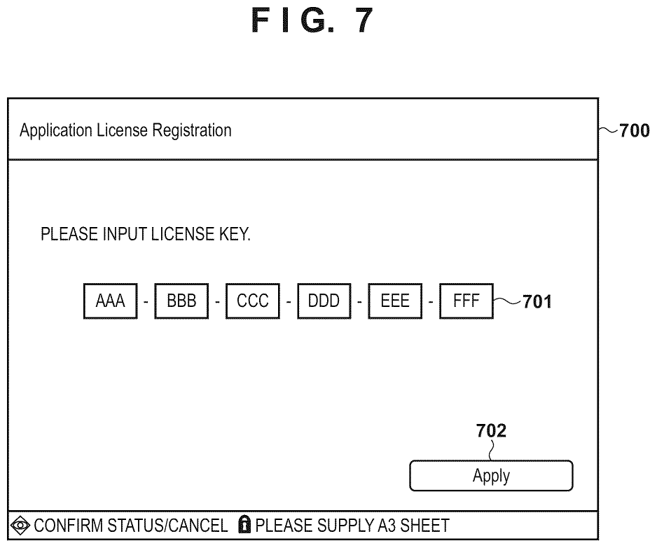

In step S601, application management 322 of the image forming apparatus 200 receives, from the device administrator, an instruction requesting a registration screen for a usage license of the cloud print service 100, and displays a license registration screen in the operation unit 261. The license registration screen displayed in the operation unit 261 in step S601 will be described with reference to FIG. 7. The device administrator enters a license key for extending the functions of the image forming apparatus 200, which the device administrator has already obtained, into a license key entry field 701 through the operation unit 261. The device administrator can then apply the corresponding license to the image forming apparatus 200 by touching an “apply” icon 702. It is assumed here that the device administrator has entered the usage license key of the cloud print service 100 in the license registration screen displayed in step S601.

In step S602, along with the entered license key, application management 322 transmits a serial number of the image forming apparatuses 200 as identification information to the cloud print service 100 through the network I/F 270. In step S603, the cloud print service 100 receives the license key and the serial number from step S602 through the network I/F 170, and license management 412 verifies the license key. If license management 412 determines that the license key is a valid license key for the cloud print service 100, the sequence moves to step S604.

In step S604, license management 412 registers the image forming apparatus 200 having the serial number received in step S603 in the database 424 as a device with which the cloud print service 100 can be used. Note that if the same administrator executes the processing from steps S601 to S604 for a plurality of image forming apparatuses 200, the plurality of image forming apparatuses 200 are set to belong to the same tenant.

In step S605, license management 412 transmits an application for using the cloud print service 100 to the image forming apparatus 200 through the network I/F 170. In step S606, application management 322 of the image forming apparatus 200 installs the received application for using the cloud print service in the image forming apparatus 200. Through this processing, cloud print 333 in FIG. 3 can be used in the image forming apparatus 200. In step S607, cloud print 333 obtains the model information and capability information of the image forming apparatus 200 from data management 353, and transmits the information to the cloud print service 100 through the network I/F 270.

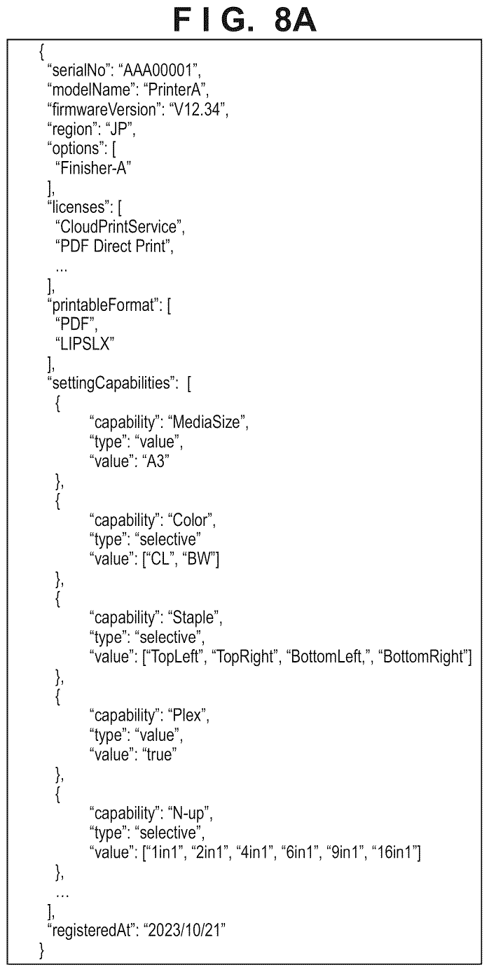

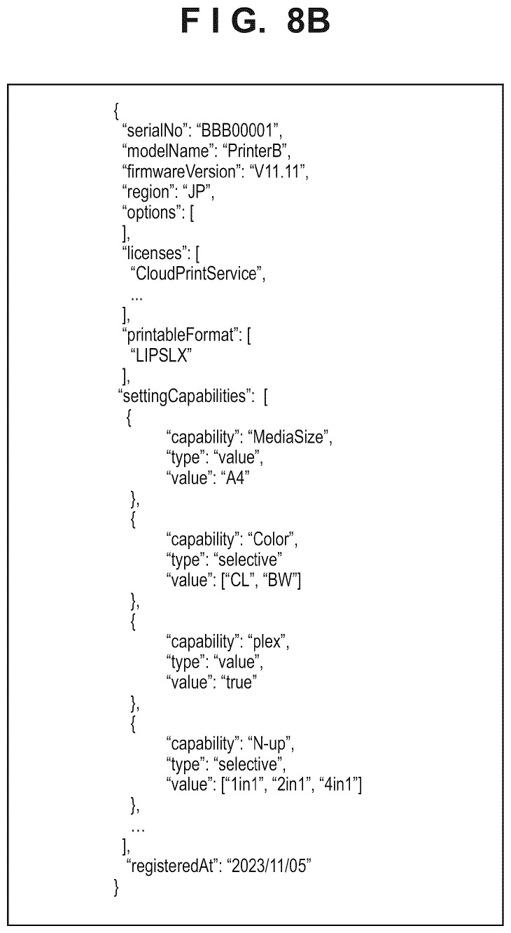

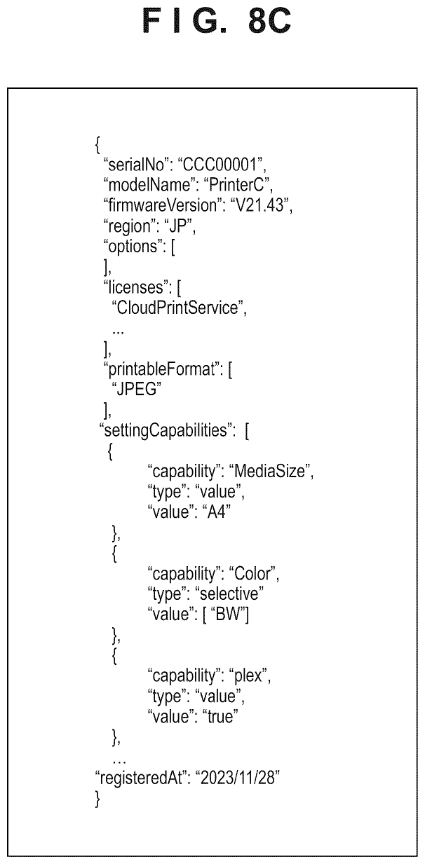

The model information and capability information of the image forming apparatus 200, transmitted by cloud print 333 in step S607, will be described next with reference to FIGS. 8A to 8C. In the example illustrated in FIGS. 8A to 8C, “serialNo” indicates the serial number, “modelName” indicates the model, and “firmwareVersion” indicates the firmware version. “Region” indicates the country for use, “options” indicates items attached to the image forming apparatus such as a finisher, and “licenses” indicates a list of registered licenses. “printableFormat” indicates data formats that can be printed, and “settingCapabilities” indicates print settings that can be used in the image forming apparatus 200. “registeredAt” indicates a registration date/time, and “settingCapabilities” indicates the capability information of the image forming apparatus 200. “settingCapabilities” further includes items “capability”, “type”, and “value” for each of the usable print settings. “capability” indicates the item name of the print settings, “type” indicates the type of the print settings value, and “value” indicates the value range of the print settings that can be used.

To be more specific, in FIG. 8A, in the image forming apparatus 200 for which “serialNo” is “AAA00001”, the output sheet size setting “MediaSize” is a setting value defined by “value”, and is “A3” here. This indicates that the image forming apparatus 200 for “AAA00001” provides functions such as printing onto A3 paper. The color setting “Color” is a setting value defined by “selective”, and here, “CL”, which represents color, and “BW”, which represents black and white, indicate that the value can be selected at the time of printing.

The stapling setting “Staple” is a setting value defined by “selective”. Here, the stapling position being selectable from four locations on the output paper, namely “TopLeft” at the upper-left, “TopRight” at the upper-right, “BottomLeft” at the lower-left, and “BottomRight” at the lower-right, is indicated. A double-sided setting “Plex” indicates that the value is a setting value defined by “value”, and that the value is “true”, i.e., that double-sided printing is possible. A page layout setting “N-up” indicates that the value is a setting value defined by “selective”, and that the value can be selected from page layout setting values “1 in 1”, “2 in 1”, “4 in 1”, “6 in 1”, “9 in 1”, or “16 in 1”.

The differences between FIG. 8A and FIG. 8B will be described next. In FIG. 8B, in the image forming apparatus 200 for which “serialNo” is “BBB00001”, the setting value for the paper size setting “MediaSize” is “A4”, which provides functions such as printing onto A4 paper. The stapling setting “Staple” is not usable, and the page layout setting “N-up” indicates that only “1 in 1”, “2 in 1”, or “4 in 1” can be used. The differences between FIG. 8A and FIG. 8C will be described next. In FIG. 8C, in the image forming apparatus 200 for which “serialNo” is “CCC00001”, only black and white, i.e., “BW”, can be selected for the color setting “Color”. The stapling setting “Staple” and the page layout setting “N-up” are indicated as unusable.

The descriptions will now return to the flowchart in FIG. 6. In step S608, the print application 414 of the cloud print service 100 receives the configuration information and capability information of the image forming apparatus 200 through the network I/F 170. The print application 414 then searches the registered serial numbers for a number that matches the serial number contained in the received model information and capability information. The received model information and capability information are then registered in the database 424 in association with the matching serial number. The sequence then ends. Executing the sequence as described above results in the image forming apparatus 200 being registered with the cloud print service 100 as a device capable of using the cloud print service 100.

### Processing Example 2 (Downloading Installer)

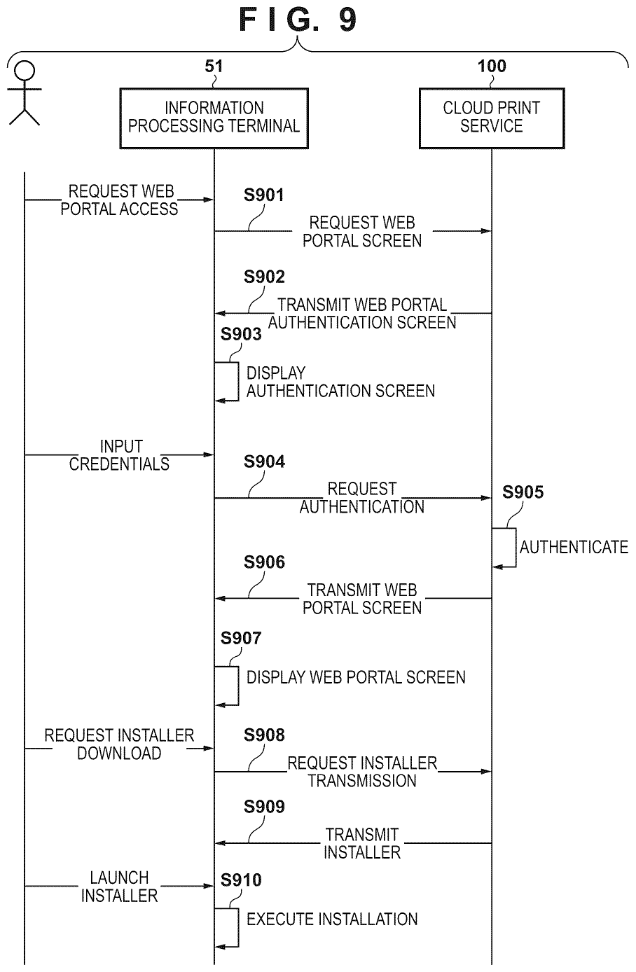

The flow of a sequence for installing a PC application for displaying various web portal screens in the information processing terminal 51, and for using the cloud print service 100 in the information processing terminal 51, will be described next with reference to FIG. 9. This sequence is realized by the information processing terminal 51 and the cloud print service 100 executing processing for each other while communicating over the network 10. The processing by the information processing terminal 51 is realized by programs stored in the ROM 514 being read out into the RAM 513 and executed by the CPU 512. Similarly, the processing by the cloud print service 100 is realized by programs stored in the ROM 140 being read out into the RAM 130 and executed by the CPU 120. Note that this sequence is executed when an end user of the cloud print service 100 launches the web page display unit 520, such as a web browser of the information processing terminal 51.

In step S901, the web page display unit 520 receives, from the end user, an access request for access to the web portal 421 of the cloud print service 100. The web page display unit 520 then requests the screen of the web portal 421 from the cloud print service 100 through the network communication unit 510.

In step S902, the web portal 421 of the cloud print service 100 accepts the request for the screen of the web portal 421 through the network I/F 170. The web portal 421 then transmits an authentication screen for logging into the web portal 421 to the information processing terminal 51 through the network I/F 170.

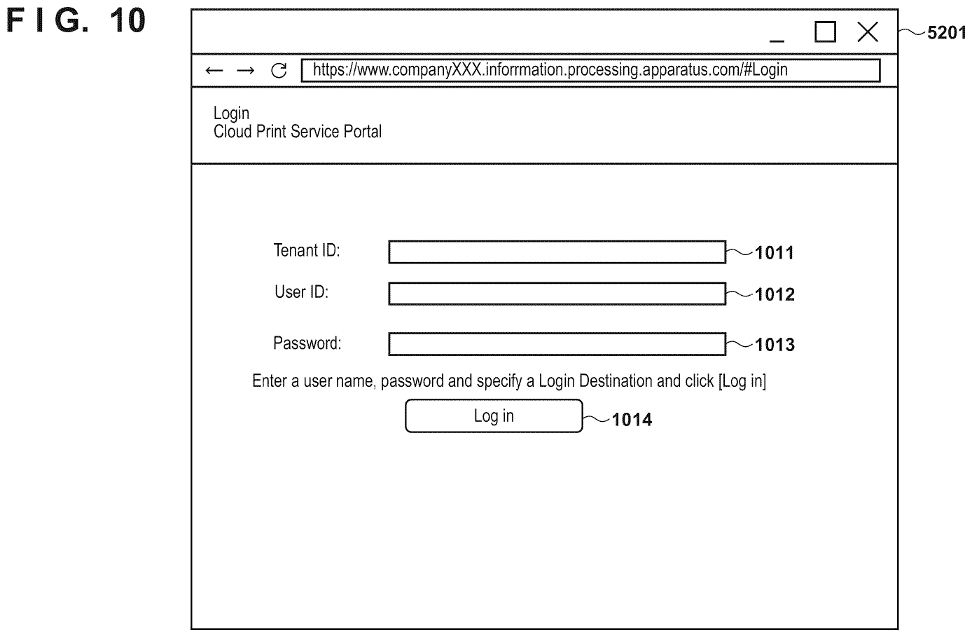

In step S903, the network communication unit 510 of the information processing terminal 51 receives the authentication screen. The web page display unit 520 then displays the authentication screen in the operation unit 516. This authentication screen will be described with reference to FIG. 10. Tenant ID, user ID, and password entry fields 1011 to 1013, which are for entering information necessary for authentication of the cloud print service 100, are arranged on a web page 5201 displayed on the web browser of the information processing terminal 51. A button 1014 for confirming the entries in the entry fields 1011 to 1013 is also provided in the web page 5201. The end user enters credentials for logging into the cloud print service 100 in the entry fields 1011 to 1013, and touches the button 1014. The web page display unit 520 then detects the button 1014 being touched.

In step S904, the web page display unit 520 transmits the authentication request, along with the credentials entered by the end user, to the cloud print service 100. In step S905, the web portal 421 of the cloud print service 100 receives the authentication request. The web portal 421 then inputs the received credentials to authentication management 413, and authentication management 413 verifies the credentials. It is assumed here that the verification of the credentials indicates that the credentials are correct.

In step S906, the web portal 421 transmits the screen of the web portal 421 to the information processing terminal 51. The network communication unit 510 of the information processing terminal 51 receives the screen of the web portal 421. In step S907, the web page display unit 520 displays the screen of the web portal 421 in the operation unit 516.

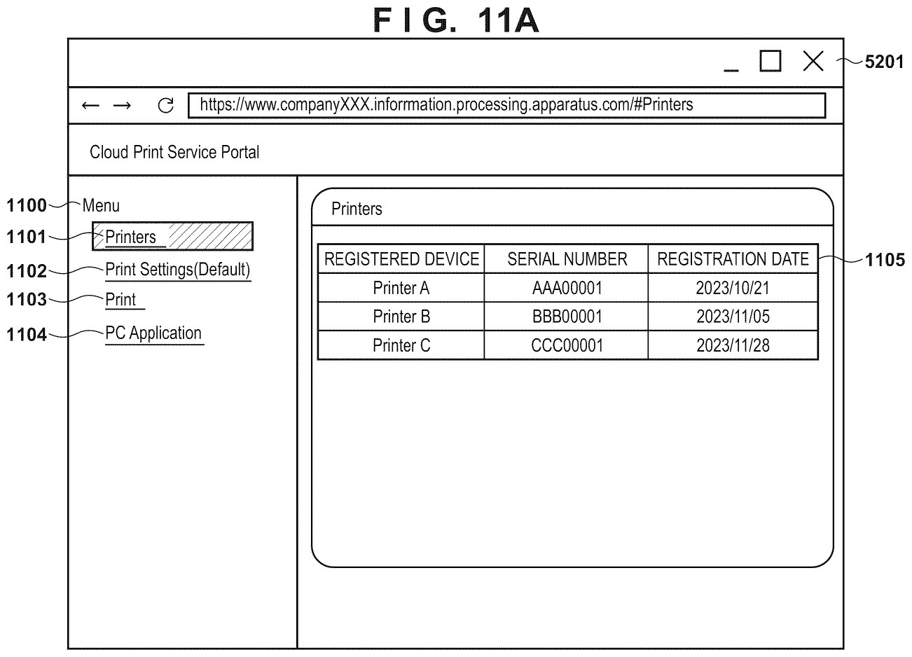

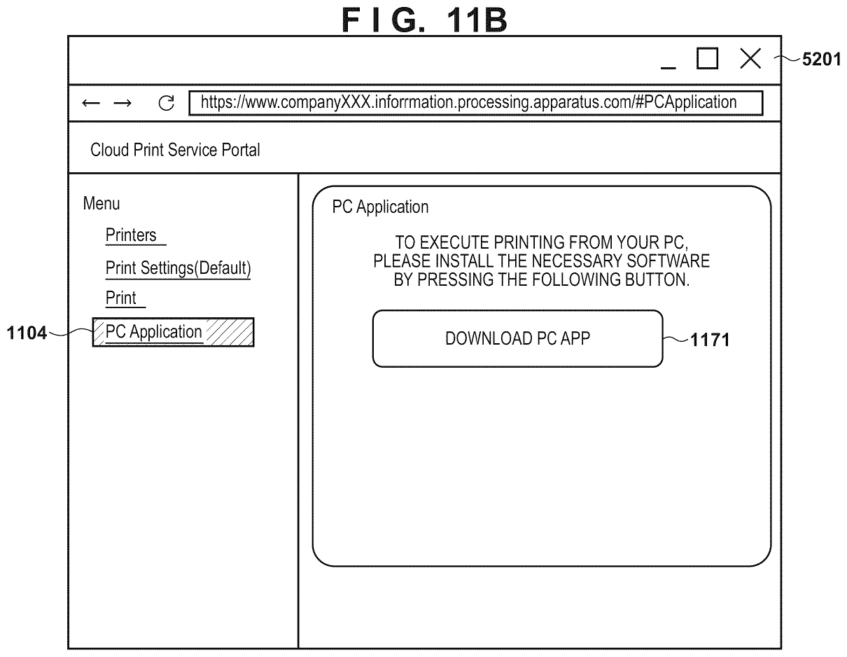

The screen of the web portal 421 displayed by the web page display unit 520 on the web page 5201 will be described with reference to FIGS. 11A and 11B. A menu 1100 is displayed on the left side of the screen of the web portal 421. A registered printer list menu 1101, a print settings menu 1102, a print instruction menu 1103, and a settings menu 1104 for the PC application 540 are displayed as sub-menus constituting the menu 1100.

More specifically, FIG. 11A illustrates the screen of the web portal 421 displayed when the end user selects the registered printer list menu 1101. A registered printer list 1105 indicating a list of the image forming apparatuses 200 registered with the tenant to which the end user of the cloud print service 100 authenticated in step S905 belongs is displayed in this screen. A model name (registered device), serial number, and registration date of the registered printer are displayed in the registered printer list 1105. Note that these display items are merely examples, and other items, e.g., the model information or capability information of each registered printer, may be displayed as well.

FIG. 11B illustrates the screen of the web portal 421 displayed when the settings menu 1104 of the PC application 540 has been selected. A button 1171 for downloading the installer 530 is displayed in this screen. The end user of the cloud print service 100 authenticated in step S905 downloads the installer 530 by touching the button 1171. The end user can then install the PC application 540 and the printer driver 550 in the PC by operating the installer 530. Such processing makes it possible for the end user to submit a desired file as a print job from software installed in the PC, such as word processing software, spreadsheet software, presentation software, or the like. The sequence for installing the PC application 540 and the printer driver 550, and the sequence for instructing printing, will be described later.

The descriptions will now return to FIG. 9. In step S908, the web page display unit 520 accepts a touch operation on the screen of the web portal 421. Here, the web page display unit 520 accepts an input for selecting the settings menu 1104 of the PC application 540 illustrated in FIG. 11A. The web page display unit 520 then displays the screen illustrated in FIG. 11B, and accepts a touch operation on the button 1171 for downloading the installer 530. The web page display unit 520 then transmits, to the cloud print service 100, a download request for downloading the installer 530.

In step S909, the web portal 421 of the cloud print service 100 receives the download request for the installer 530, obtains the installer 530 stored in the storage 423, and transmits the installer to the information processing terminal 51. Note that the format of the installer 530 to be transmitted is an installation executable file format or a format in which tenant information of the tenant to which the end user belongs is compressed, and is a format that can be loaded and executed by the end user using the OS function of the information processing terminal 51.

In step S910, the network communication unit 510 of the information processing terminal 51 receives the installer 530. Then, in the information processing terminal 51 that has received the PC application 540, the installer 530 is launched in response to an instruction from the end user, e.g., an instruction to execute the executable file. The PC application 540 and the printer driver 550 are then installed. The sequence then ends. Note that the processing of this sequence will be described in detail later.

### Processing Example 3 (PC Application and Printer Driver Installation Processing)

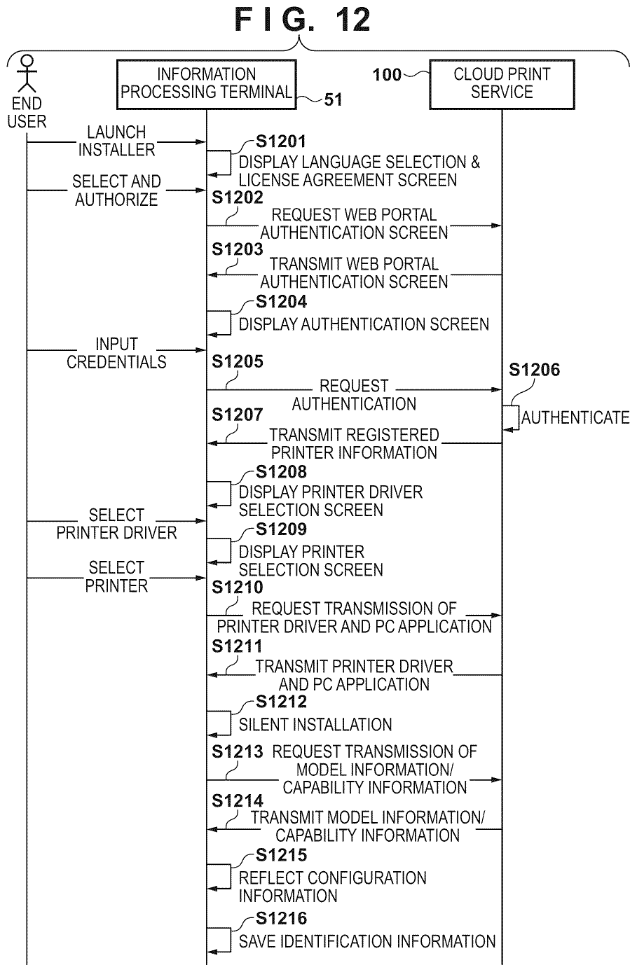

The flow of a sequence for executing the installer 530 downloaded to the information processing terminal 51 and installing the PC application 540 and the printer driver 550 will be described next with reference to FIG. 12. This sequence is realized by the information processing terminal 51 and the cloud print service 100 executing processing for each other while communicating over the network 10. The processing by the information processing terminal 51 is realized by programs stored in the ROM 514 being read out into the RAM 513 and executed by the CPU 512. Similarly, the processing by the cloud print service 100 is realized by programs stored in the ROM 140 being read out into the RAM 130 and executed by the CPU 120.

In step S1201, the installer 530 of the information processing terminal 51 accepts a launch operation from the end user through the operation unit 516. The installer 530 then displays a language selection screen and a license agreement screen. Selectable languages displayed by the installer 530 in the language selection screen correspond to the languages that can be displayed by the cloud print service 100. In addition, in the license agreement screen, the installer 530 displays a license agreement document for the end user, stating that data related to printing through the cloud print service 100 will be collected as per the agreement.

In step S1202, the installer 530 accepts operations for selecting the language and agreeing to the license agreement from the end user. The installer 530 then requests the cloud print service 100 to provide the authentication screen of the web portal 421 through the network communication unit 510. In step S1203, the web portal 421 of the cloud print service 100 that has been requested transmits the authentication screen for logging into the web portal 421 to the information processing terminal 51 through the network I/F 170.

In step S1204, the installer 530 of the information processing terminal 51 receives the authentication screen of the web portal 421 through the network communication unit 510. Then, the installer 530 uses this authentication screen to display the authentication web page 5201 (FIG. 10) as a WebView. The entry fields 1011 to 1013 and the button 1014 capable of instructing a login to the cloud print service are provided in the web page 5201. At this time, the installer 530 refers to the tenant information included in the installer 530 and displays the tenant ID in advance in the entry field 1011 in which the tenant ID can be entered. Accordingly, the end user enters credentials for logging into the cloud print service 100 in the other entry fields (1012 and 1013), and presses the button 1014 for confirming the entry.

In step S1205, the installer 530 accepts the credentials entered in the entry fields 1011 to 1013 of the web page 5201. The installer 530 then transmits the authentication request, along with the credentials entered by the end user, to the cloud print service 100 through the network I/F 270. In step S1206, the web portal 421 of the cloud print service 100 transmits the received credentials to authentication management 413. Authentication management 413 verifies the received credentials. Here, it is assumed that the credentials are successfully verified.

In step S1207, the web portal 421 obtains, from the database 424, a list of printers registered in the tenant to which the authenticated end user belongs and printer drivers corresponding to those printers. The web portal 421 then transmits list information of the printers and the printer drivers to the information processing terminal 51 through the network I/F 170. In step S1208, the installer 530 of the information processing terminal 51 receives the printer list information and the printer drivers through the network I/F 270. The installer 530 then displays a printer driver selection screen.

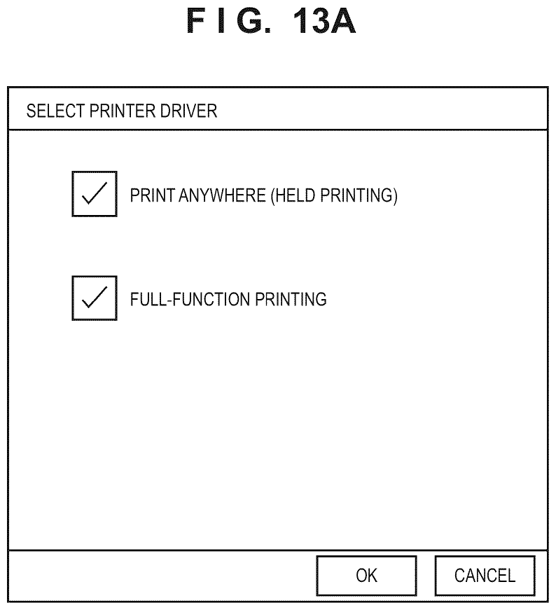

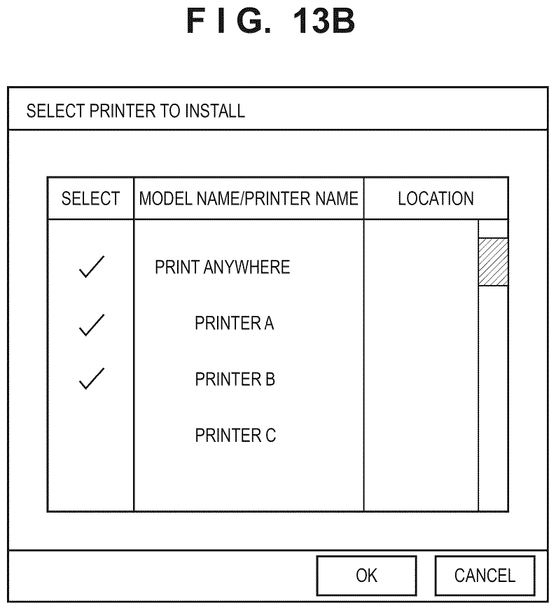

The printer driver selection screen (an example of a “selection screen”) will be described next with reference to FIG. 13A. The installer 530 displays a printer driver for on-demand printing (held printing) and a printer driver for full-function printing as printer driver options 601. The end user can select and install the printer drivers indicated in FIG. 13A. Note that the end user can select and execute the printer driver for on-demand printing (held printing) and the printer driver for full-function printing simultaneously.

In step S1209, when the end user performs a printer driver selection operation and then operates an OK button in the printer driver selection screen, the installer 530 displays a printer selection screen in which a printer registered in the tenant can be selected. The printer selection screen (an example of a “selection screen”) will be described with reference to FIG. 13B. The purpose of displaying the printer selection screen is to install a printer driver specialized for the printer selected by the end user. Accordingly, the printer selection screen is configured in accordance with the printer selected in the printer driver selection screen. In other words, the “on-demand printing” indicated in FIG. 13A is associated with the “on-demand printing” option shown in FIG. 13B. Likewise, the “full-function printing” illustrated in FIG. 13A is associated with “printer A”, “printer B”, and “printer C”, which are options aside from the “on-demand printing” illustrated in FIG. 13B. Note that the printers displayed in the printer selection screen may be limited in accordance with the privileges of the user registered in the tenant.

In step S1210, the end user operates the OK button after performing a printer selection operation in the printer selection screen. The installer 530 then requests the cloud print service 100 to obtain the printer driver 550 selected by the end user, the PC application 540, and a port monitor through the network I/F 517. In step S1211, the CPU 120 of the cloud print service 100 obtains the printer driver 550, the PC application 540, and the port monitor stored in the storage 423. The CPU 120 then transmits the printer driver 550, the PC application 540, and the port monitor to the information processing terminal 51 using the network I/F 170.

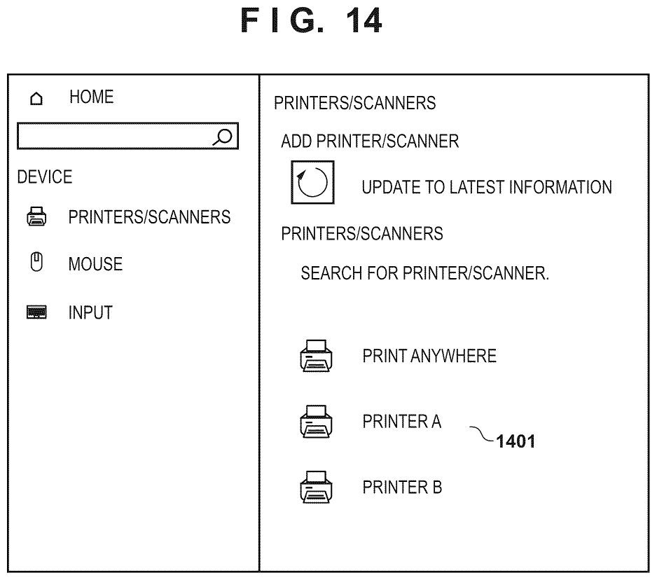

In step S1212, the installer 530 of the information processing terminal 51 receives the port monitor, the PC application 540, and the printer driver 550. The installer 530 then executes a silent installation in this order. A device information screen managed by the OS 360 will be described next with reference to FIG. 14. Once the installation of the printer driver 550 is complete, the OS 360 adds a printer queue name to a region 1401 of the device information screen in which the list of printers is displayed. At this time, the added printer queue includes a configuration specialized for the printer designated by the end user. In addition, the displayed printer queue name is obtained from the cloud print service 100, and information regarding the printer designated by the end user is reflected therein. Here, it is assumed that, for example, a model name of the printer designated by the end user in the printer selection screen illustrated in FIG. 13B is used for the printer queue name.

In step S1213, the installations of the port monitor, the PC application 540, and the printer driver 550 are completed. The installer 530 then transmits the identification information of the printer designated by the end user to the cloud print service 100 through the network I/F 517, and requests the model information and capability information of the printer. In step S1214, the CPU 120 of the cloud print service 100 receives the request through the network I/F 170, and based on the identification information, obtains the model information and capability information of the printer from the list of printer information registered in the database 424. The CPU 120 then transmits the model information and capability information of the printer to the information processing terminal 51 through the network I/F 170.

In step S1215, the installer 530 (an example of a “first obtainment unit”) receives the model information and capability information of the printer through the network I/F 517. The installer 530 then causes the printer driver 550 installed in step S1212 to reflect the information including the model information and the capability information as configuration information. At this time, the model information and capability information of the printer registered in the database 424 in the cloud print service 100 are a format such as that illustrated in FIGS. 8A to 8C. Accordingly, the installer 530 (an example of a “conversion unit”) converts the received model information into a format that can be recognized by the printer driver 550.

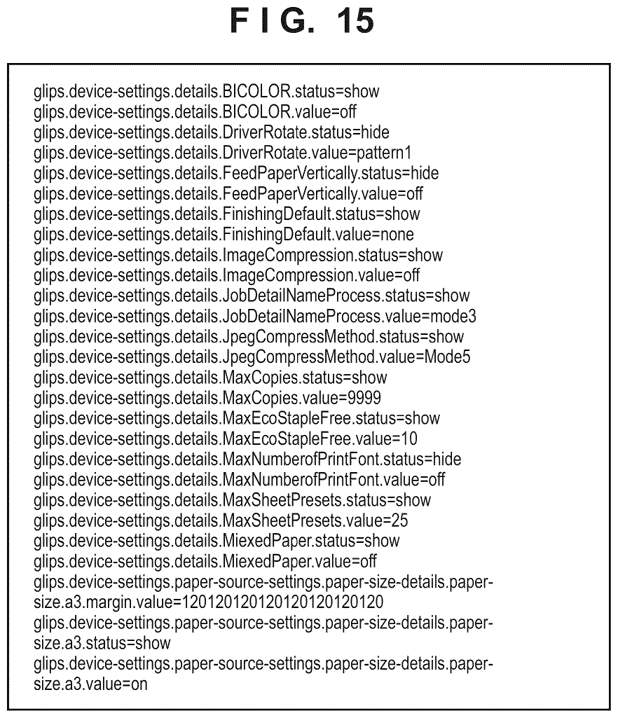

The format of configuration information that can be recognized by the printer driver 550 will be described with reference to FIG. 15. FIG. 15 illustrates an example of the model information illustrated in FIGS. 8A to 8C being converted into the typ file format, which is a data format that can be recognized by the printer driver 550. For example, “glips.Device-settings.Details.MaxCopies” indicates a maximum number of copies. “glips.device-settings.details.BICOLOR” indicates bicolor printing. In addition, “glips.device-settings.details.FinishingDefault” indicates the finisher state. In addition to these functions, the installer 530 converts information including information indicating whether other functions and the like are active or inactive into a data format that can be recognized by the printer driver 550, and causes that information to be reflected in the printer driver 550 as the configuration information of the image forming apparatus.

Note that in the present embodiment, the data format is converted because the format of the model information and capability information registered in the cloud print service 100 differs from the format of the configuration information that can be recognized by the printer driver 550. However, configuration information in a format that can be recognized by the printer driver may be registered in the cloud print service 100. In such a case, the data format need not be converted.

In step S1216, the installer 530 passes the identification information held by the printer queue generated through the installation of the printer driver 550, and the identification information of the printer designated by the end user, to the PC application 540 and registers that information therein. The processing then ends. Hereinafter, the identification information held by the printer queue is also referred to as “queue identification information”. The identification information of the printer is also referred to as “printer identification information”. The registration sequence will be described below.

### Processing Example 4 (Printer Identification Information Registration Processing)

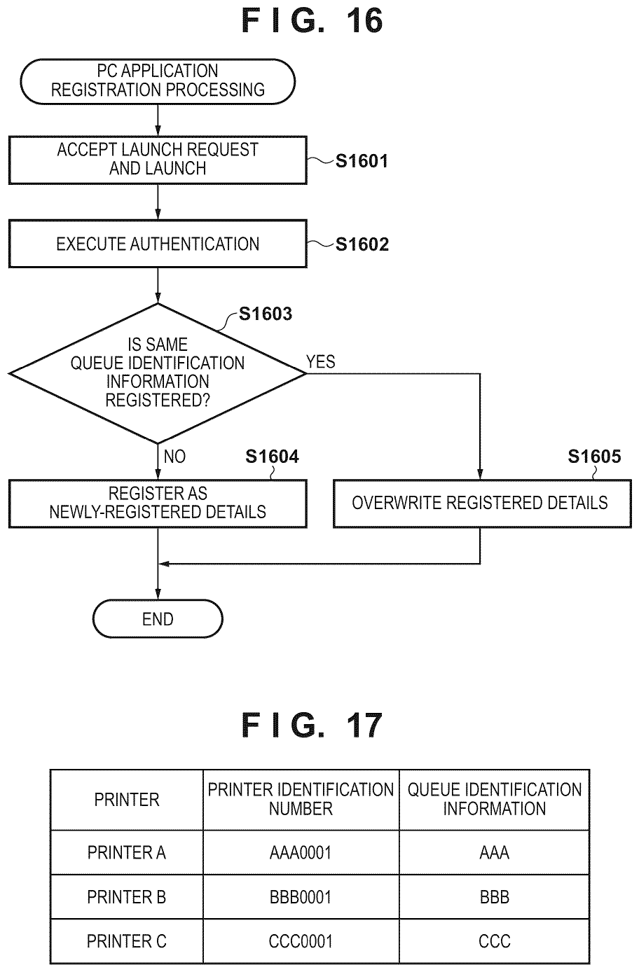

The flow of processing for registering the identification information of a printer by the PC application 540 immediately after installation in the information processing terminal 51 will be described with reference to FIG. 16. Note that this processing is realized by programs stored in the ROM 514 of the information processing terminal 51 being read out into the RAM 513 and executed by the CPU 512.

In step S1601, the PC application 540 is launched in response to a launch request from the aforementioned installer 530. At this time, the PC application 540 receives the printer identification information, the queue identification information, and an access token to the cloud print service 100 along with the launch request. Note that the installer 530 passes not only the identification information, but also information such as the printer model name and the like, to the PC application 540 in order to associate the identification information (described later).

In step S1602, the PC application 540 first requests that the end user authenticate with the cloud print service 100. However, here, the PC application 540 has received the access token issued by the installer 530 through the authentication, and thus authentication is not required in this step. Note that if the expiration date of the access token has passed and a revocation error occurs, the PC application 540 requests the end user to perform authentication.

In step S1603, the PC application 540 associates each item of the identification information received from the installer 530 with the other information. FIG. 17 is an example of displaying a correspondence relationship between the identification information and the other information in list format, for example. Here, the printer identification information designated by the end user is associated with the queue identification information of the printer queue in which the identification information is to be reflected, and the printer model name is used as the information for identifying the registration details. The serial number of the printer may be used instead of the model name of the printer.

The PC application 540 then determines whether the same queue identification information is already registered in a storage medium such as the RAM 513. If the PC application 540 determines that the same printer queue identification information is already registered, the sequence moves to step S1605. In step S1605, the PC application 540 overwrites the registered details with the stated associated details and saves those details in a storage medium such as the RAM 513. The processing then ends. However, if the PC application 540 determines in step S1603 that the identification information of the printer queue is not registered, the sequence moves to step S1604. In step S1604, the PC application 540 stores (registers) the stated associated details in a storage medium such as the RAM 513 as newly-registered details. The processing then ends. Note that the storage medium such as the RAM 513 is an example of a “first storage unit that stores identification information of a predetermined image forming apparatus and identification information of a queue in association with each other”.

When a request to obtain the configuration information from the printer driver 550 (described later) has been made through the foregoing sequence, the PC application 540 obtains the model information and capability information from the cloud print service 100. The PC application 540 can then convert the obtained information into configuration information and pass the configuration information to the printer driver 550.

### Processing Example 5 (Processing for Obtaining Configuration Information through Selection Made in Properties Screen)

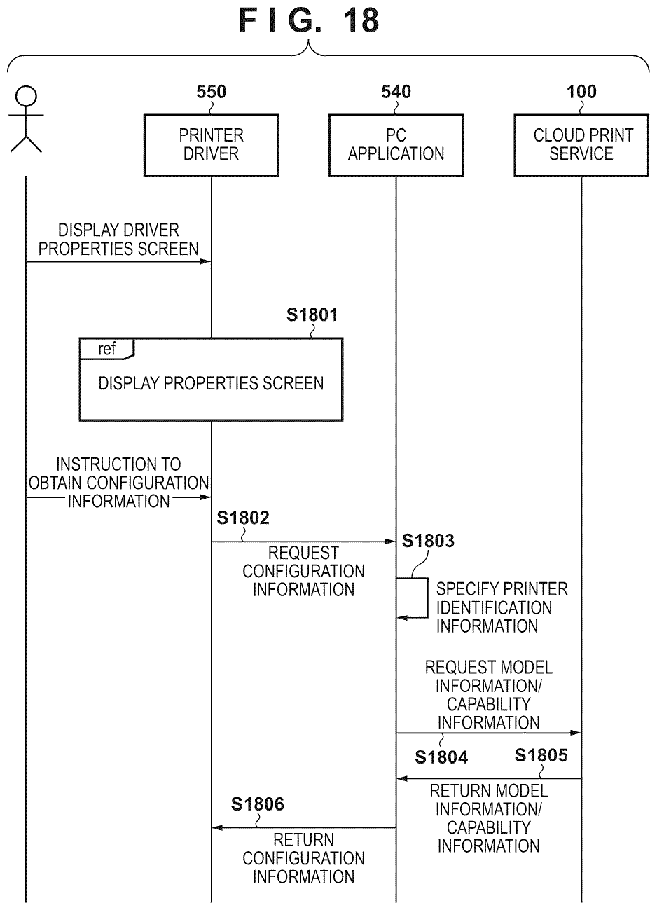

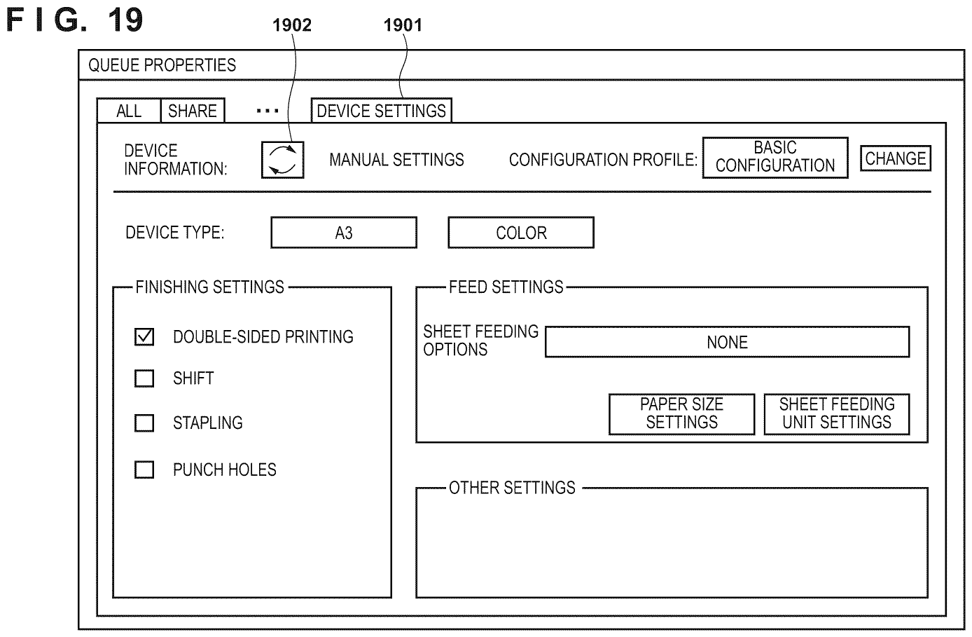

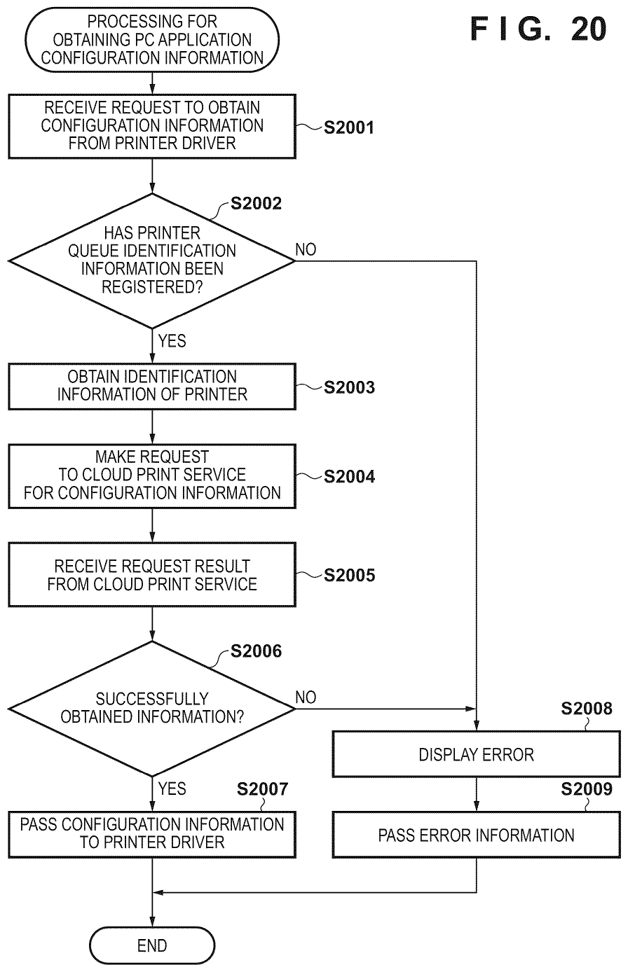

The flow of a sequence performed when the end user has made a request to obtain the configuration information of the printer will be described next with reference to FIGS. 18 and 19. Note that this sequence is realized by the information processing terminal 51 and the cloud print service 100 executing processing for each other while communicating over the network 10. The processing by the information processing terminal 51 is realized by programs stored in the ROM 514 being read out into the RAM 513 and executed by the CPU 512. Similarly, the processing by the cloud print service 100 is realized by programs stored in the ROM 140 being read out into the RAM 130 and executed by the CPU 120.

In step S1801, the printer driver 550 accepts a properties setting request operation from the printer queue list screen illustrated in FIG. 14. The printer driver 550 then displays a printer queue properties screen. FIG. 19 illustrates the printer queue properties screen (an example of an “update screen in which specific information can be updated”). The properties screen illustrated in FIG. 19 includes a device settings screen 1901 pertaining to device settings, and an object 1902 for selecting obtainment of the configuration information of the device (an example of a “first object”).

In step S1802, the printer driver 550 accepts, on the screen displayed when the device settings screen 1901 is selected, an operation for changing the configuration settings or obtaining the configuration information from the end user. “Changing the configuration settings” refers to, for example, changing the print settings that are dependent on the model information of the image forming apparatus displayed in the device settings screen 1901 (settings for whether to staple or punch holes, in FIG. 19). The “operation for obtaining the configuration information” refers to an operation input made using the object 1902. Here, the printer driver 550 is assumed to accept an operation for obtaining the configuration information. The printer driver 550 then transmits the configuration information obtainment request and the queue identification information to the PC application 540.

In step S1803, the PC application 540 receives the request to obtain the configuration information. The PC application 540 then specifies the printer identification information by reading the information from a storage medium such as the RAM 513 using the queue identification information received from the printer driver 550. The correspondence relationship between the printer identification information and the queue identification information, such as the table illustrated in FIG. 17, is used for specifying the printer identification information. In step S1804, the PC application 540 transmits the printer identification information to the cloud print service 100 using the network communication unit 510, and furthermore requests the model information and the capability information.

In step S1805, the CPU 120 of the cloud print service 100 specifies the configuration information of the printer corresponding to the received printer identification information from the database 424. Note that the configuration information includes the model information and the capability information of the printer. The CPU 120 then transmits the configuration information to the information processing terminal 51 using the network I/F 170.

In step S1806, the PC application 540 of the information processing terminal 51 receives the configuration information through the network communication unit 510. The PC application 540 then passes the received configuration information to the printer queue through the printer driver 550. However, as in step S1215, the PC application 540 converts the model information and the capability information included in the received configuration information into the data format illustrated in FIG. 15 before passing that information to the printer driver 550. On the other hand, if the configuration information is received from the cloud print service 100 in the data format illustrated in FIG. 15, the PC application 540 passes the configuration information to the printer driver 550 as-is in that data format. The processing then ends.

### Processing Example 6 (Processing for Passing Configuration Information for PC Application 540)

The flow of processing in which, in the processing sequence illustrated in FIG. 19, the PC application 540 of the information processing terminal 51 passes the configuration information to the printer driver 550 in response to the request to obtain the configuration information from the printer driver 550, will be described in detail next with reference to FIG. 20. Note that this processing is realized by programs stored in the ROM 514 of the information processing terminal 51 being read out into the RAM 513 and executed by the CPU 512.

In step S2001, the printer driver 550 accepts a touch operation of the object 1902 indicating the obtainment of the configuration information of the device illustrated in FIG. 19, and transmits a request to obtain the configuration information and the queue identification information to the PC application 540. The PC application 540 receives the request to obtain the configuration information and the queue identification information.

In step S2002, the PC application 540 determines whether the received queue identification information is registered in association with the printer identification information, as in the table information illustrated in FIG. 17. If the PC application 540 determines that the queue identification information is registered, the sequence moves to step S2003. In step S2003, the PC application 540 obtains the printer identification information associated with the queue identification information. For example, if queue identification information “AAA” is received, the PC application 540 specifies and obtains printer identification information “AAA00001” as indicated in the table information of FIG. 17. The sequence then moves to step S2004.

In step S2004, the PC application 540 transmits the printer identification information obtained in step S2003 to the cloud print service 100 through the network communication unit 510. The PC application 540 also requests the model information and capability information of the printer corresponding to that printer identification information. In the cloud print service 100, the CPU 120 receives the printer identification information and the request. The CPU 120 then searches out the model information and capability information of the printer, including the printer identification information, from the list of printer information registered in the database 424. The CPU 120 then transmits the result to the information processing terminal 51 using the network I/F 170.

In step S2005, the PC application 540 of the information processing terminal 51 receives the result of the request through the network communication unit 510. In step S2006, the PC application 540 (an example of a “determination unit”) determines whether the model information and capability information of the printer requested by the cloud print service 100 in step S2004 have been successfully obtained. If the PC application 540 determines that the model information and capability information of the printer have been successfully obtained, the sequence moves to step S2007.

In step S2007, the PC application 540 passes the received configuration information (model information and capability information) to the printer driver 550 that made the request. At this time, if the received configuration information is in a format such as that illustrated in FIGS. 8A to 8C, the PC application 540 converts the format of the configuration information into the data format illustrated in FIG. 15, which can be recognized by the printer driver 550. Or, configuration information in a format that can be recognized by the printer driver 550 may be registered in the cloud print service 100. In such a case, the PC application 540 does not convert the format of the received configuration information, and passes the configuration information to the printer driver 550 as-is in that data format. The processing then ends.

On the other hand, if in step S2006 the PC application 540 determines that the model information and capability information of the printer have not been successfully obtained, the sequence moves to step S2008. The sequence then moves to step S2009 and ends.

If the PC application 540 determines in step S2002 that the identification information is not registered, the sequence moves to step S2008. In step S2008, the PC application 540 displays an error message. In step S2009, the PC application 540 returns the error information to the printer driver 550. The processing then ends.

In this manner, in the present embodiment, the end user touches the object 1902, which indicates the obtainment of the configuration information of the device, on the properties screen illustrated in FIG. 19. The printer driver 550 then reflects the configuration information in the printer queue through the PC application 540 as described above in Processing Examples 5 and 6. In addition, when, for example, the PC application 540 is launched in addition to the information processing terminal 51 being started up, the PC application 540 may execute the following processing. That is, the PC application 540 polls the model information and the capability information corresponding to all the printer identification information registered in the PC application 540 from the cloud print service 100. The PC application 540 may then convert the information into configuration information and reflect the configuration in the printer queue.

Through the sequence described above, the PC application 540 reflects the update of the configuration information of the image forming apparatus 200 designated by the end user in the printer queue. Such an update of the configuration information makes it possible for the information processing terminal 51 to display a print settings screen for full-function printing that includes all the print settings that can be used in the image forming apparatus 200.

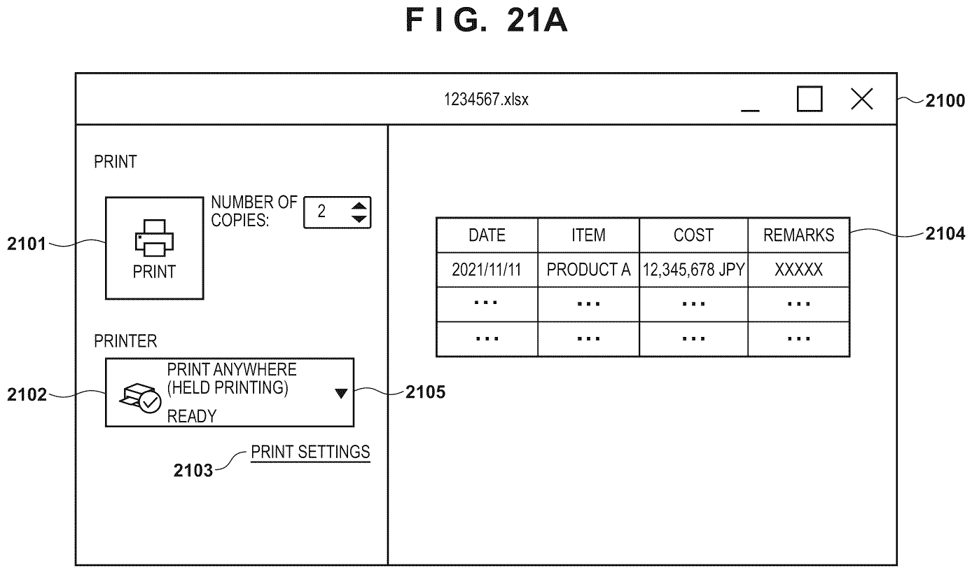

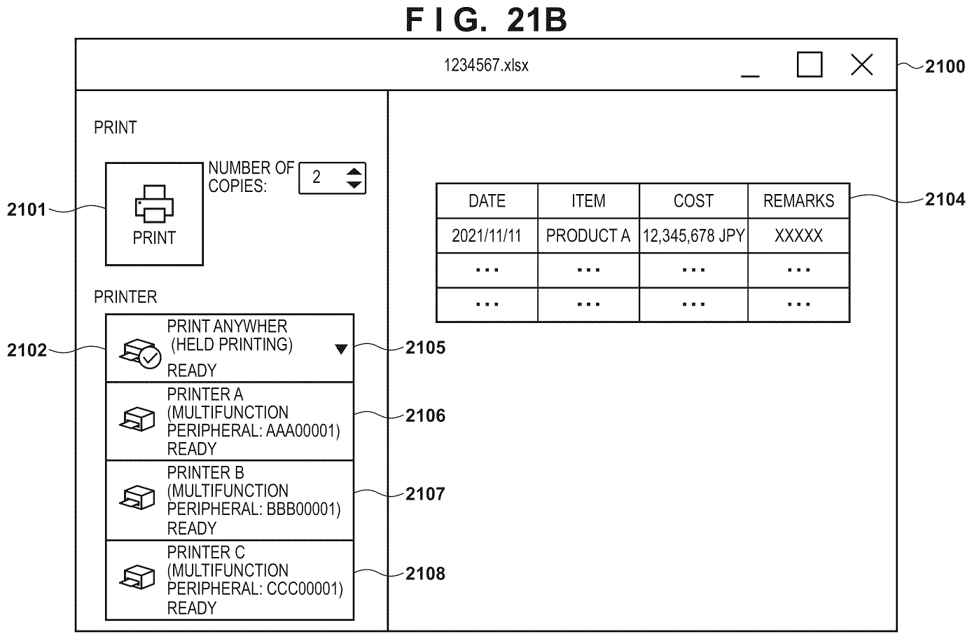

A print instruction screen in which print instruction operations for the cloud print service 100 can be performed from the information processing terminal 51 (an example of an “image forming instruction screen”) will be described with reference to FIG. 21A. FIG. 21A illustrates a print instruction screen for instructing the cloud print service 100 to print a file opened using spreadsheet software installed in the information processing terminal 51. By operating such a print instruction screen, the printer queue in which the PC application 540 installed in the information processing terminal 51 and the configuration information are updated can be used.

FIG. 21A illustrates an example of a state in which a file called “1234567.xlsx” has been opened in spreadsheet software and a software print instruction screen has been opened in a window 2100. A print instruction button 2101 (an example of a “third object”), a printer selection pull-down display 2102, a print settings button 2103 (an example of a “second object”), and a print preview display 2104 are displayed in the window 2100. Through the sequence described earlier with reference to FIG. 12, the PC application 540 and the printer driver 550 are obtained from the cloud print service 100 and installed in the information processing terminal 51. A list of printer queues for using the cloud print service 100 is then displayed in the printer selection pull-down display 2102 (FIG. 21B).

The print settings button 2103 is a button for instructing the print settings screen corresponding to the printer queue selected in the pull-down display 2102 to be displayed. Note that the flow of displaying the print settings screen and an example of the screen will be described later with reference to FIGS. 21A, 21B, 22, 23A, and 23B. The user selects the printer queue in the pull-down display 2102 and touches the print instruction button 2101. The CPU 512 then passes the data of the opened file and the print settings data set at that point in time to the printer driver 550 associated with the printer queue. The PC application 540 then transmits (submits) the data (also called “submitted data” hereinafter) to the cloud print service 100 through the network communication unit 510.

A selection operation made using the pull-down display 2102 will be described with reference to FIGS. 21A and 21B. In the pull-down display 2102, an object 2105 indicating “on-demand printing (held printing)” is displayed. The print instruction button 2101 is touched while such an object 2105 is selected. The submitted data transmitted by the CPU 512 of the information processing terminal 51 to the cloud print service 100 is then stored (held) in the cloud print service 100. The user can then execute the printing in any of the image forming apparatuses 200 registered with the cloud print service 100, at any desired timing, in accordance with the flow described later.

On the other hand, when the object 2105 is touched in the print instruction screen illustrated in FIG. 21A, objects 2106 to 2108 are displayed in parallel with the object 2105. The objects 2106 to 2108 correspond to the printer queues of the image forming apparatuses 200 selected by the end user in the printer selection screen illustrated in FIG. 13B, in which the configuration information has been reflected, for example. In the print settings screen illustrated in FIG. 21B, the object 2106 illustrated in FIG. 11A corresponds to the printer queue associated with the configuration information of “printer A (AAA00001)” registered with the cloud print service 100 by the installer 530. Likewise, the object 2107 corresponds to the printer queue associated with the configuration information of “printer B (BBB00001)”. Furthermore, the object 2108 corresponds to the printer queue associated with the configuration information of “printer C (CCC00001)”. When the user selects any of the objects 2106 to 2108 and touches the print instruction button 2101, printing can be executed by the selected image forming apparatus 200. Note that the print settings screen illustrated in FIG. 21B is an example of an “image forming instruction screen”.

### Processing Example 7 (Print Job Transmission Processing)

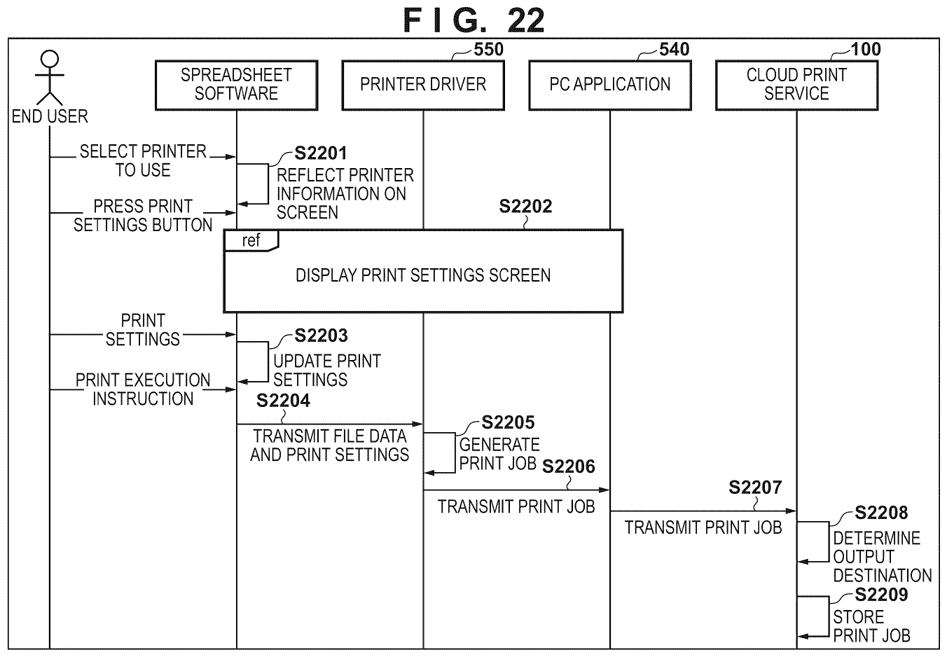

The flow of a sequence for submitting a print job generated by the printer driver 550 to the cloud print service 100 through the PC application 540 installed in the information processing terminal 51 will be described with reference to FIG. 22. This sequence is realized by the information processing terminal 51 and the cloud print service 100 executing processing for each other while communicating over the network 10. The processing by the information processing terminal 51 is realized by programs stored in the ROM 514 being read out into the RAM 513 and executed by the CPU 512. Similarly, the processing by the cloud print service 100 is realized by programs stored in the ROM 140 being read out into the RAM 130 and executed by the CPU 120. Note that the processing of this sequence is started when the end user of the cloud print service 100 operates the screen illustrated in FIG. 21A. It is also assumed that spreadsheet software is installed in the information processing terminal 51 in advance.

In step S2201, the spreadsheet software displays, in the print instruction screen, the printer information corresponding to the printer queue selected by the end user in the print instruction screen (FIGS. 21A and 21B). In other words, the end user selects one of the objects 2105 to 2108 corresponding to the printer queue from the pull-down display 2102 illustrated in FIG. 21B. The spreadsheet software then displays the printer information corresponding to the selected printer queue in the print instruction screen, as illustrated in FIG. 21A.

In step S2202, when the end user touches the print settings button 2103 (FIG. 21A) in the print instruction screen, the CPU 512 displays the print settings screen corresponding to the printer queue selected in step S2201. At this time, when the printer queue for on-demand printing is selected, the CPU 512 generates a print settings screen that includes setting items common to all the printers. However, when the printer queue for an individual model is selected, the CPU 512 displays a print settings screen for full-function printing that reflects the configuration information of the printer associated with the printer driver for that model. Note that the setting items common to all the printers may be items that include an union of the print settings that can be used, i.e., the print settings that can be used in any of the image forming apparatuses 200. Alternatively, the common setting items may be items that include an intersection, i.e., the print settings that can be used by any of the image forming apparatuses 200.

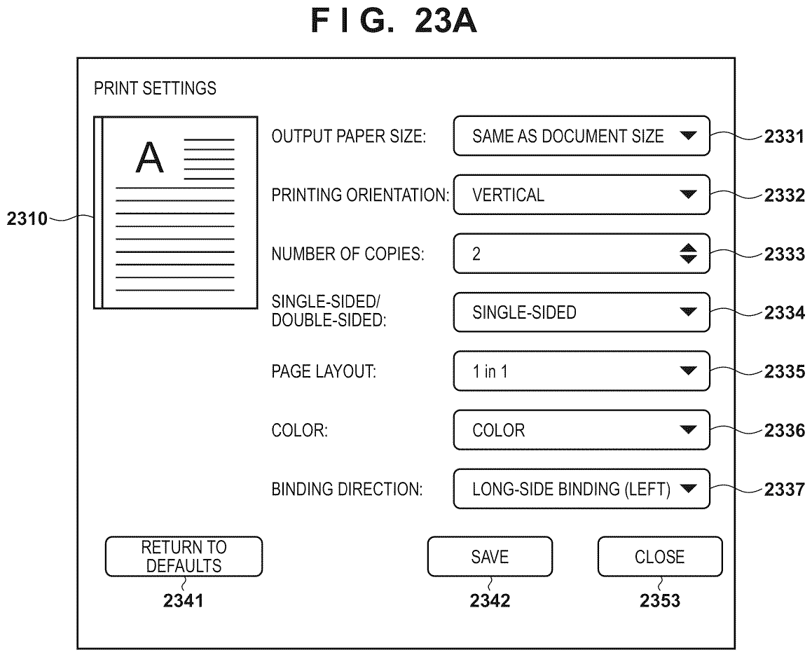

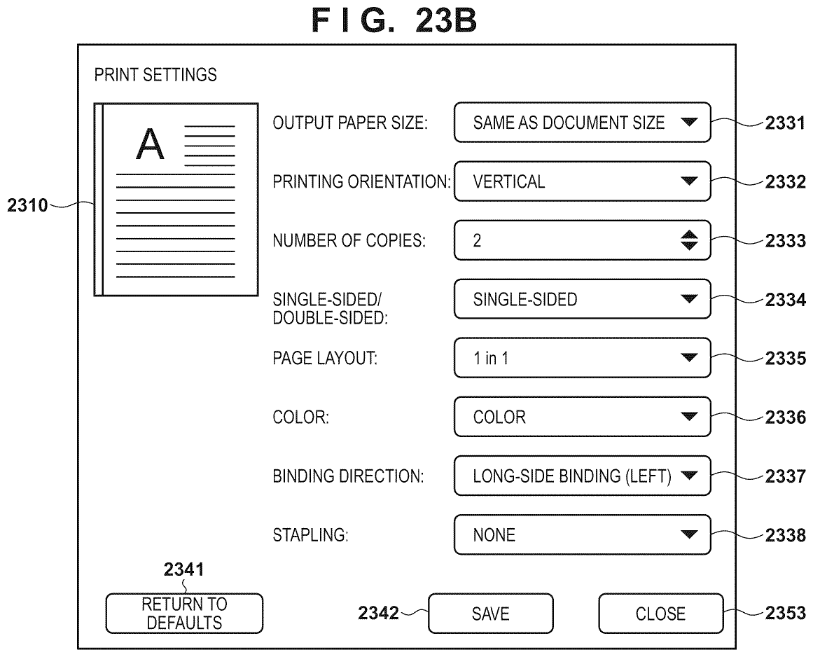

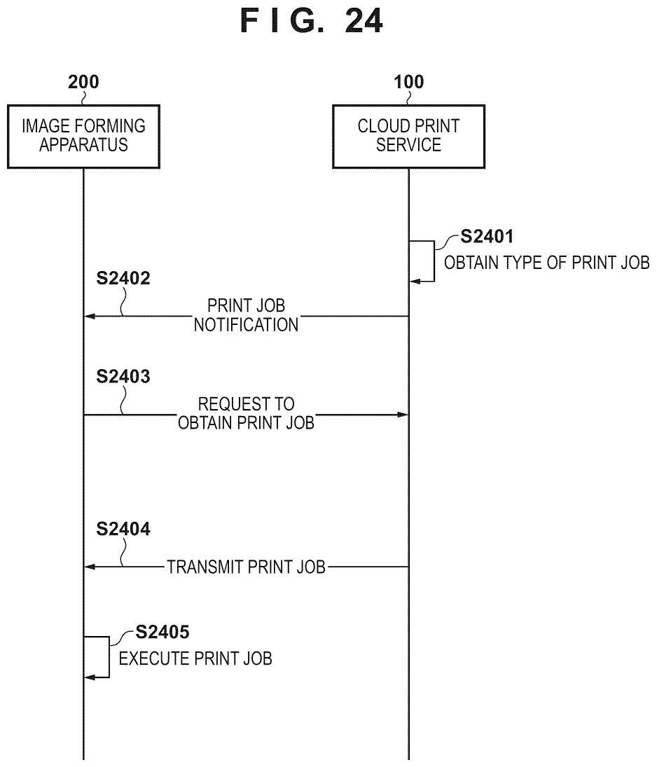

The print settings screen (an example of the “image forming settings screen”) will be described with reference to FIGS. 23A and 23B. FIG. 23A illustrates the print settings screen for held printing in which print settings common to all printers are displayed. On the other hand, FIG. 23B illustrates a print settings screen for full-function printing specialized for the printer A (AAA00001).

The print settings screen illustrated in FIG. 23A displays print settings common to a plurality of image forming apparatuses 200 registered with the cloud print service 100. In other words, in the print settings screen, the setting items displayed for corresponding ones of print settings 2331 to 2337 are items that can be set in common for the plurality of image forming apparatuses 200. Such setting items are, for example, “output sheet size” (print settings 2331), “printing orientation” (print settings 2332), “number of copies” (print settings 2333), and “single-sided/double-sided” (print settings 2334). Additionally, such setting items are, for example, “page layout” (print settings 2335), “color” (print settings 2336), and “binding direction” (print settings 2337).

On the other hand, the print settings screen illustrated in FIG. 23B displays the maximum print settings provided in the printer A (AAA00001). In other words, if the printer A (AAA00001) is an image forming apparatus 200 provided with a finisher function, print settings 2338 that allows specification of whether to add stapling are displayed in the print settings screen illustrated in FIG. 23B in addition to the print settings 2331 to 2337 described above. Note that the finisher provided in the printer A is an example of a “processing unit”. Additionally, the print settings screens illustrated in FIGS. 23A and 23B include a button 2341 for making a touch operation to return the print settings state to a default state.

The descriptions will return to the processing sequence illustrated in FIG. 22. In step S2203, the spreadsheet software (an example of an “accepting unit”) updates the print settings set by the end user in the print settings screen displayed in step S2202 as the print settings for use in subsequent submitted data generation processing. The update processing is executed by the spreadsheet software accepting a touch operation by the end user of a “save” button 2342 or a “close” button 2353 in the print settings screen illustrated in FIG. 23A or FIG. 23B. In other words, if the “save” button 2342 is touched, the spreadsheet software sets the print settings set at that point in time as the print settings for use in the submitted data generation processing. However, if the “close” button 2353 is touched, the spreadsheet software sets the print settings at the point in time when step S2202 is started as the print settings for use in the submitted data generation processing.

In step S2204, the spreadsheet software accepts a touch operation of the print instruction button 2101 in the print instruction screen (FIG. 21A) by the end user. The spreadsheet software then transmits the file to be printed and the print settings data set in step S2203 to the printer driver 550 associated with the printer queue selected by the end user.

In step S2205, the printer driver 550 receives the file to be printed and the print settings data. From this data, the printer driver 550 (an example of an “instruction unit”) then generates a print job in a format that can be identified by the outputting printer. Here, the data format is converted in accordance with the type of the printer driver 550. For example, if the printer driver 550 is a PDF driver, the data is converted into PDF format, whereas if the printer driver 550 is a Generic Plus driver, the data is converted into a zu printer description language format such as LIPSLX or UFR2.

In step S2206, the printer driver 550 passes the generated print job to the PC application 540. In step S2207, the PC application 540 transmits the print job generated by the printer driver 550 to the cloud print service 100 through the network communication unit 510. At this time, in addition to the print job, information such as the identification information of the image forming apparatus 200 and the registered device name of the image forming apparatus 200 are also transmitted as information for specifying the image forming apparatus 200 for the output.

In step S2208, the print application 414 of the cloud print service 100 (an example of a “second obtainment unit”) receives the print job through the network I/F 170. The print application 414 then determines whether the print job is a held print job (an example of a “first instruction”) or a full-function print job (an example of a “second instruction”). The print application 414 also determines which image forming apparatus 200 is the image forming apparatus 200 that is to output the received print job. Note that this determination may be executed using the format of the received print job. Alternatively, this determination may be executed using information such as the identification information of the image forming apparatus 200 or the registered device name of the image forming apparatus 200, which are information, received along with the print job, for specifying the image forming apparatus 200 for output.

In step S2209, the print application 414 saves the print job in the storage 423 (an example of a “second storage unit”) using the result of the determination made in step S2208. In other words, the print application 414 associates, with the print job, the information of the print job, information that can identify the end user who submitted the data involved in this flow (a user ID or the like), and the information of the image forming apparatus 200 that executes the printing as determined in step S2208. The print application 414 then saves the print job in the storage 423. Alternatively, if the print job is a print job generated by a printer driver for held printing, the print application 414 may add and save information indicating the held printing, such as, for example, a character string “any” indicating any desired registered printer. Alternatively, if the print job is a print job generated by a printer driver other than a driver for held printing, the print application 414 may transmit the print job to a specified image forming apparatus 200 without saving the print job in the storage 423. The processing sequence then ends.

### Processing Example 8 (print Job Execution Processing)

A processing sequence performed by a specific image forming apparatus 200 for printing among the print jobs saved in the cloud print service 100 through the processing sequence illustrated in FIG. 22 will be described next with reference to FIG. 24. This sequence is realized by the cloud print service 100 and the image forming apparatus 200 executing processing for each other while communicating over the network 10. The processing by the cloud print service 100 is realized by programs stored in the ROM 140 being read out into the RAM 130 and executed by the CPU 120. Similarly, the processing by the image forming apparatus 200 is realized by programs stored in the ROM 240 being read out into the RAM 230 and executed by the CPU 220. It is also assumed that this processing sequence is executed in response to a print job being saved in the storage 423 of the cloud print service 100 in step S2209 of the processing sequence illustrated in FIG. 22.

In step S2401, the print application 414 of the cloud print service 100 obtains the print job saved in the storage 423 in step S2209. The print application 414 then determines whether the print job is a held print job or a full function print job. The print application 414 also determines which image forming apparatus 200 is the image forming apparatus 200 to which the print job is to be transmitted. This determination is executed in the same manner as the method of the determination made in step S2208 for the print job. Note that if the print job is determined in step S2208 to have been generated by a printer driver other than the printer driver for held printing, and the print job was not saved in the storage 423 in step S2009, the following processing is executed. In other words, the print application 414 only determines the destination of the print job using the result from step S2208.

In step S2402, the print application 414 obtains the information of the image forming apparatus 200 to execute the printing, which is included in the print job. The print application 414 then notifies the image forming apparatus 200 that is to execute the printing of the identification information of the print job through the network I/F 170. The notification in this processing is performed as follows between the image forming apparatus 200 and the cloud print service 100. In other words, the notification is performed by including the identification information of the print job in the payload of a push notification made through a protocol capable of real-time bidirectional communication such as WebSocket or MQTT, for example.

In step S2403, cloud print 333 of the image forming apparatus 200 is notified of the identification information of the print job through the network I/F 270. Then, though the network I/F 270, cloud print 333 requests the cloud print service 100 to obtain print data in a format that can be printed by the image forming apparatus 200. More specifically, cloud print 333 transmits information identifying the image forming apparatus 200 in which cloud print 333 is installed (e.g., including a serial number) to the cloud print service 100. Here, it is assumed that the image forming apparatus 200 to which the end user has made the print instruction in accordance with the sequence flow illustrated in FIG. 22 is “Printer A” in the registered printer list 1105 indicated in the screen of the web portal 421 illustrated in FIG. 11A. Accordingly, the print data obtainment request in step S2403 includes the serial number “AAA00001” of “Printer A”. The print application 414 of the cloud print service 100 then receives the request through the network I/F 170.

In step S2404, the print application 414 that received the print data obtainment request determines whether the data format of the target print job is a printable format on the basis of the details of the request. Then, if the print application 414 determines that the data format of the print job is a printable format, the print application 414 transmits the print job to the image forming apparatus 200 through the network I/F 170. Cloud print 333 of the image forming apparatus 200 receives the print job through the network I/F 270. In step S2405, cloud print 333 executes the printing processing according to the print execution instruction included in the print job received in step S2404 through the job/device control 352. The processing then ends.

### Actions and Effects

According to the image forming system 1 described above, print settings can be applied in accordance with each item of model information of the image forming apparatus 200 selected in the printer selection screen illustrated in FIG. 13B. Accordingly, the user can select settings from the maximum number of print setting items in the image forming apparatus 200 that they themselves have selected, and execute a full print. This improves the convenience for the user.

### First Variation

The foregoing embodiment assumed that the information processing terminal 51 is capable of obtaining the configuration information including the model information and capability information of the image forming apparatus 200 from the cloud print service 100. However, a first variation will describe an example of printing processing when the information processing terminal 51 is unable to obtain the configuration information from the cloud print service 100. Note that the descriptions of the first variation will omit descriptions of parts where the configurations and processing sequences are the same as in the foregoing embodiment.

### Processing Example 9 (PC Application and Printer Driver Installation Processing)

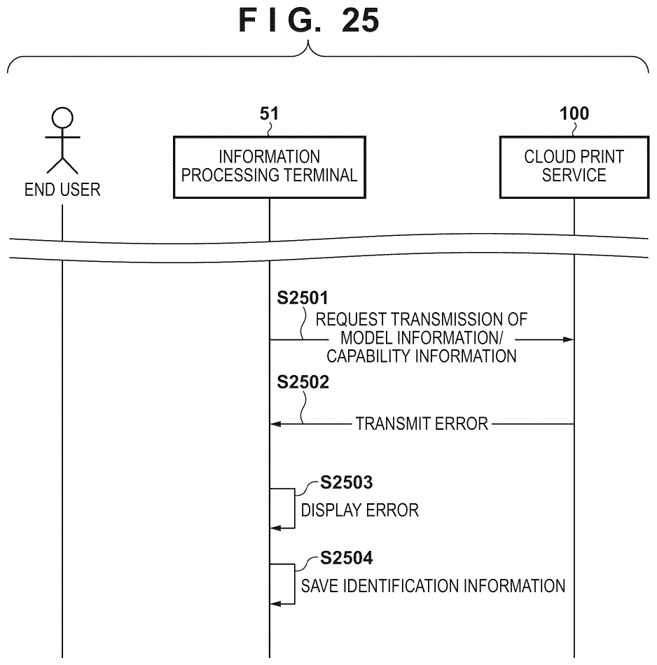

A variation on Processing Example 3 illustrated in FIG. 12 will be described with reference to FIG. 25. This sequence is realized by the information processing terminal 51 and the cloud print service 100 executing processing for each other while communicating over the network 10. The processing by the information processing terminal 51 is realized by programs stored in the ROM 514 being read out into the RAM 513 and executed by the CPU 512. Similarly, the processing by the cloud print service 100 is realized by programs stored in the ROM 140 being read out into the RAM 130 and executed by the CPU 120.

The processing prior to step S2501 illustrated in FIG. 25 is the same as the processing from steps S1201 to step S1212 illustrated in FIG. 12. In other words, the end user selects the image forming apparatus 200 in the printer selection screens illustrated in FIGS. 13A and 13B, which are displayed by the installer 530 in the information processing terminal 51. The installer 530 then downloads and installs the port monitor, the PC application, and the full-function printer driver selected by the user from the cloud print service 100.

When the printer driver 550 is installed by the installer 530, a printer queue name is added to the region 1401 that displays the list of printers in the device information screen illustrated in FIG. 14. The user can then check the printer queue properties screen, such as that illustrated in FIG. 19. When the device settings screen 1901 is further selected in this properties screen, a screen for accepting, from the end user, an operation for changing the configuration settings or obtaining the configuration information is displayed.

Here, the installer 530 already holds basic information (including the capability information) regarding the image forming apparatus 200 selected by the user in the printer selection screen illustrated in FIGS. 13A and 13B. The print settings functions that can be set by the image forming apparatus 200 are then displayed in the device settings screen 1901 immediately after the installation. However, of the print settings functions provided with a check button for selection (the functions listed in the finishing settings in the device settings screen 1901 illustrated in FIG. 19), the check buttons are checked in advance for print setting items common to the image forming apparatuses 200. It is furthermore assumed that the check button is not checked for print setting items dependent on the configuration information (including the model information) of the individual image forming apparatuses 200.

To be more specific, the check button is checked in advance for “double-sided printing”, which is an example of a print setting item common to the image forming apparatuses 200, in the device settings screen 1901. On the other hand, a finisher is attached to the image forming apparatus selected by the user, for example. Shift sorting is provided such that when the finisher discharges sheets to the tray, the position of the discharged sheets is shifted every predetermined number of copies. In such a case, “shift” is displayed in the device settings screen 1901, and the check button corresponding to the “shift” remains unchecked. In addition, a finisher that automatically staples a bundle of sheets that have been output, for example, is attached to the image forming apparatus selected by the user. In such a case, “staple” is displayed in the device settings screen 1901, and the check button corresponding to the “staple” remains unchecked. In addition, a finisher that automatically punches a sheet that has been output, for example, is attached to the image forming apparatus selected by the user. In such a case, “punch” is displayed in the device settings screen 1901, and the check button corresponding to the “punch” remains unchecked. The sequence then moves to step S2501.

In step S2501, the installer 530 transmits a request to the cloud print service 100 for obtaining the model information and capability information of the image forming apparatus 200 for which the identification information of the image forming apparatus 200 has been assigned through the network I/F 517. The CPU 120 of the cloud print service 100 receives the request through the network I/F 170, and based on the identification information, searches out the model information and capability information of the image forming apparatus 200 from the list of printer information registered in the database 424. However, in the first variation, it is assumed that the CPU 120 cannot find information matching the identification information of the image forming apparatus 200, or that the registered information is incomplete and the CPU 120 cannot perform the identification, and thus the obtainment of the model information and the capability information fails.

In step S2502, the CPU 120 transmits error information or empty information to the information processing terminal 51 through the network I/F 170. In step S2503, the installer 530 of the information processing terminal 51 receives the error information or the empty information. The installer 530 then displays error information including text indicating the failure to obtain the configuration information (an example of an “error message”) in the operation unit 516. Here, the print settings in the printer queue properties screen illustrated in FIG. 19 remain in the setting state effective immediately after the installation of the printer driver 550. Accordingly, if the user wishes to use print settings in the unchecked state, it is necessary for the user to manually check the corresponding check button in the device settings screen 1901. The installer 530 therefore includes a method for print settings using the check button and print setting items displayed in the device settings screen 1901 in the error information displayed in the operation unit 516. In this manner, the installer 530 may prompt the user to activate the function of print settings in the unchecked state. The printer driver 550 then accepts a check operation if the user has checked a print setting item in the unchecked state.

In step S2504, even if the obtainment of the model information and the capability information has failed as described above, the installer 530 passes the queue identification information, the printer identification information, and other information to the PC application 540 and registers that information. The correspondence relationship of the information registered in this manner is illustrated in FIG. 17, for example. At this time, the installer 530 may also register information indicating that the obtainment of the configuration information stored in the cloud print service 100 has failed. The processing then ends.

### Processing Example 10 (Processing for Passing Configuration Information for PC Application 540)

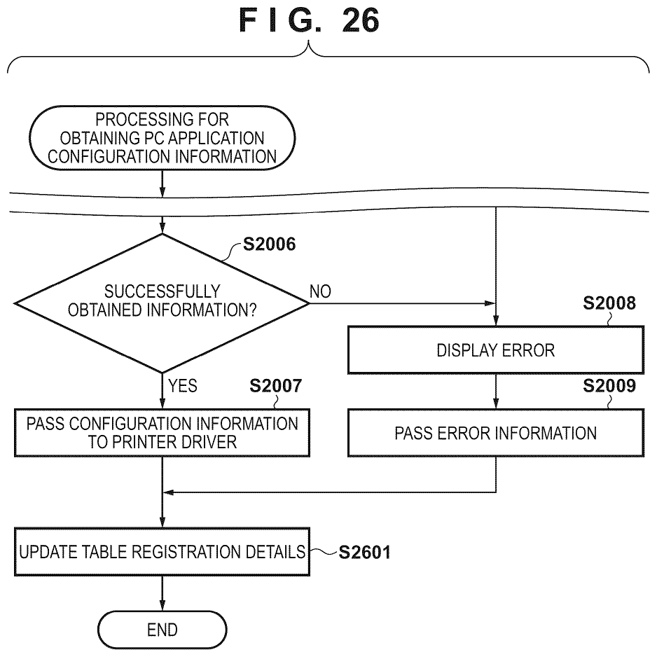

The flow of processing in which, in the processing sequence illustrated in FIG. 25, the PC application 540 of the information processing terminal 51 passes the configuration information to the printer driver 550 in response to the request to obtain the configuration information from the printer driver 550, will be described in detail next with reference to FIG. 26. Note that this processing is realized by programs stored in the ROM 514 of the information processing terminal 51 being read out into the RAM 513 and executed by the CPU 512.

If the user touches the object 1902 indicating the obtainment of the configuration information of the device in the queue properties screen illustrated in FIG. 19, the same processing as in Processing Example 6, illustrated in FIG. 20, is executed in the information processing terminal 51. However, in the first variation, in step S2006, the PC application 540 (an example of a “determination unit”) determines that the model information and capability information of the image forming apparatus 200 requested by the cloud print service 100 in step S2004 have not been successfully obtained. Accordingly, the PC application 540 passes error information to the printer queue.

However, there are cases where the configuration information including the model information and the capability information is re-registered or updated in the database 424 of the cloud print service 100 thereafter. In such a case, the PC application 540 of the information processing terminal 51 once again becomes capable of obtaining the model information and capability information from the cloud print service 100. Alternatively, there are cases where the configuration information including the model information and the capability information that were obtainable before can no longer be obtained. In these cases, in step S2601, which follows step S2009, the PC application 540 may update the table information illustrated in FIG. 17, i.e., the registration details (an example of a “storage state”), in accordance with the status of the obtainment of the model information and capability information. In other words, if the model information and the capability information have been newly obtained, the PC application 540 may overwrite and save the information for which the registration details have been obtained in a storage medium such as the RAM 513. On the other hand, if the model information and the capability information cannot be obtained, the PC application 540 may delete the registration details from the storage medium such as the RAM 513. The processing then ends. Note that printing is possible even when the obtainment of the configuration information has failed in this manner. The flow of the printing may be the same as the flow illustrated in FIG. 22, for example.

### Actions and Effects

According to the first variation, even if the configuration information (the model information and capability information) cannot be obtained from the cloud print service 100 once, the PC application 540 can obtain the configuration information from the cloud print service 100 again. The first variation therefore provides the same effects as the embodiment.

### Other Variations

If, in step S1209, the end user performs the printer driver selection operation on the printer driver selection screen illustrated in FIG. 13A and then operates the OK button, the installer 530 may skip displaying the printer selection screen illustrated in FIG. 13B. The installer 530 may then request the cloud print service 100 to obtain the printer driver 550, the PC application 540, and the port monitor of the image forming apparatuses included in the tenant to which the end user belongs.

The configuration information may also include, for example, information on the operation state of the finisher with respect to the image forming apparatus. The “information on the operation state”, for example, information indicating that the power of the finisher is on or off, that the finisher is operating normally or malfunctioning, or the like. Even among image forming apparatuses of the same model, such information is specific to that particular image forming apparatus. When the finisher is powered on or is operating normally, stapling is treated as active. However, if the finisher is powered off or is malfunctioning, stapling is treated as inactive.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-209751, filed Dec. 2, 2024, which is hereby incorporated by reference herein in its entirety.

What is claimed is:

1. An information processing apparatus capable of communicating with a cloud print server that provides a cloud print service, the information processing apparatus comprising:
one or more memory devices that store a set of instructions; and
one or more processors that execute the set of instructions to:
obtain specific information regarding an image formation of an image forming apparatus capable of communicating with the cloud print server;
accept a setting in accordance with the obtained specific information, the setting pertaining to the image formation in the image forming apparatus; and
issue an instruction for the image formation in the image forming apparatus, the instruction including the setting.

2. The information processing apparatus according to claim 1,
wherein the one or more processors further execute instructions in the one or more memory devices to:
display a selection screen for selecting a predetermined image forming apparatus from among a plurality of image forming apparatuses;
accept a selection of the predetermined image forming apparatus in the selection screen; and
obtain the specific information of the predetermined image forming apparatus that was selected.

3. The information processing apparatus according to claim 2,
wherein the one or more processors further execute instructions in the one or more memory devices to:
display, in the selection screen, an object enabling selecting execution of the image formation in a desired one of the image forming apparatuses at a desired timing.

4. The information processing apparatus according to claim 2,
wherein the one or more processors further execute instructions in the one or more memory devices to:
display an update screen through which the specific information of the predetermined image forming apparatus can be updated, the update screen including a first object for updating the specific information of the predetermined image forming apparatus;
accept an operation performed on the first object on the update screen; and
update the specific information of the predetermined image forming apparatus in accordance with the accepted operation of the first object.

5. The information processing apparatus according to claim 4,
wherein the one or more processors further execute instructions in the one or more memory devices to:
display the setting in a selectable state in the update screen; and
accept a selection of the setting in the update screen.

6. The information processing apparatus according to claim 3,
wherein the one or more processors further execute instructions in the one or more memory devices to:
display an image forming instruction screen including identification information of the predetermined image forming apparatus, a selectable second object for performing the setting in accordance with the identification information, and a selectable third object for instructing execution of the image formation in the predetermined image forming apparatus.

7. The information processing apparatus according to claim 6,
wherein the one or more processors further execute instructions in the one or more memory devices to:
display, in a case where the second object was selected, an image forming settings screen that displays the setting in a selectable state.

8. The information processing apparatus according to claim 7,
wherein the one or more processors further execute instructions in the one or more memory devices to:
display, in the image forming instruction screen, an object enabling selecting execution of the image formation in a desired one of the image forming apparatuses at a desired timing; and
in a case where execution of the image formation in a desired one of the image forming apparatuses at a desired timing was selected and furthermore the second object was selected, displaying, in a selectable state in the image forming settings screen, a setting item common to a plurality of the image forming apparatuses included in the cloud print server.

9. The information processing apparatus according to claim 2,
wherein the one or more processors further execute instructions in the one or more memory devices to:
store identification information of the predetermined image forming apparatus and identification information of a queue for the image formation executed in the predetermined image forming apparatus in association with each other;
read out, using the identification information of the queue, the stored identification information of the predetermined image forming apparatus;
transmit, to the cloud print server, the identification information of the predetermined image forming apparatus that was read out; and
obtain the specific information of the predetermined image forming apparatus from the cloud print server.

10. The information processing apparatus according to claim 9,
wherein the one or more processors further execute instructions in the one or more memory devices to:
determine whether the specific information was successfully obtained; and
in a case of determining that the specific information was not successfully obtained, display an error message indicating that the specific information was not successfully obtained and indicating a method for the setting.

11. The information processing apparatus according to claim 10,
wherein the one or more processors execute instructions in the one or more memory devices to:
update, after the error message was displayed, a storage state of the identification information of the predetermined image forming apparatus and the identification information of the queue in accordance with an obtainment state of the specific information.

12. The information processing apparatus according to claim 1,
wherein obtaining the specific information includes converting the specific information into a format recognizable by a driver of the image forming apparatus.

13. The information processing apparatus according to claim 1,
wherein the specific information includes information indicating a state of a processing unit that processes a sheet output from the image forming apparatus.

14. An information processing system comprising:
the information processing apparatus according to claim 2; and
a cloud print server,
wherein the information processing apparatus is configured to execute a first instruction instructing an image formation in the predetermined image forming apparatus and a second instruction instructing an image formation in a desired one of the image forming apparatuses at a desired timing, and
the cloud print server comprising:
one or more memory devices that store a set of instructions; and
one or more processors that execute the set of instructions to:
obtain an instruction from the information processing apparatus;
determine whether the instruction from the information processing apparatus is the first instruction or the second instruction; and
store the instruction from the information processing apparatus in accordance with a result of the determination.

15. A control method for an information processing apparatus capable of communicating with a cloud print server that provides a cloud print service, the control method comprising:
obtaining specific information regarding an image formation of an image forming apparatus capable of communicating with the cloud print server;
accepting a setting in accordance with the obtained specific information, the setting pertaining to the image formation in the image forming apparatus; and
issuing an instruction for the image formation in the image forming apparatus, the instruction including the setting.

16. A non-transitory computer-readable storage medium storing a program for causing a computer to execute each step of a control method for an information processing apparatus capable of communicating with a cloud print server that provides a cloud print service, the control method comprising:
obtaining specific information regarding an image formation of an image forming apparatus capable of communicating with the cloud print server;
accepting a setting in accordance with the specific information obtained, the setting pertaining to the image formation in the image forming apparatus; and
issuing an instruction for the image formation in the image forming apparatus, the instruction including the setting.
